(19) United States
(12) Patent Application Publication
(10) Pub. No.: US 2025/0216205 A1
(43) Pub. Date: Jul. 3, 2025

(54) METHOD, APPARATUS, AND SYSTEM FOR AUTOMATED DETECTION AND CHARACTERIZATION OF A ROAD INTERSECTION AND ADJUSTMENT

(71) Applicant: HERE Global B.V., Eindhoven (NL)

(72) Inventor: Kenneth Hal BALDWIN, Carlsbad, CA (US)

(21) Appl. No.: 18/806,388

(22) Filed: Aug. 15, 2024

Related U.S. Application Data
(60) Provisional application No. 63/615,563, filed on Dec. 28, 2023.

(51) Int. Cl. G01C 21/32; G01C 21/00

(52) U.S. Cl. CPC G01C 21/32; G01C 21/3815; G01C 21/3867

(57) ABSTRACT

An approach is provided for automated detection and/or characterization of road intersections. The approach, for instance, includes determining a set of observables associated with a road intersection. The set of observables comprises a plurality of point observations of road boundaries of the road intersection, and the plurality of point observations are collected using sensors of vehicles traveling in the road intersection. The approach also involves processing the plurality of point observations to generate a triangular mesh to represent a surface of the road intersection. The triangular mesh comprises a plurality of triangles connecting the plurality of point observations as respective vertices of a plurality of triangles. The approach further involves selecting one or more branch triangles of the plurality of triangles. The vertices of the branch triangles reference three different road boundaries of the road intersection. The approach further involves automatically detecting the intersection based on the branch triangles.

### RELATED APPLICATION

This application claims the benefit of the earlier filing date of U.S. Provisional Application Ser. No. 63/615,563 filed Dec. 28, 2023, entitled “Method, Apparatus, and System for Automated Detection and Characterization of a Road Intersection and Adjustment,” the entirety of which is incorporated herein by reference.

### BACKGROUND

Modern applications such as autonomous driving require highly detailed and accurate maps (e.g., meter or sub-meter levels of detail), particularly of complex features such as road intersections, to operate safely. However, creating digital map data at the required levels of detail and accuracy over a large geographical area demands a significant amount of time and effort. This often leads to incomplete or inconsistent representations of map features such as road intersections. Accordingly, service providers face significant technical challenges associated with obtaining map data to support advanced mapping, navigation, and other location-based applications.

### SOME EXAMPLE EMBODIMENTS

Therefore, there is a need for an approach for automated detection and characterization of intersections to create and/or update digital map data.

According to one embodiment, a method comprises determining a set of observables associated with a road intersection. The set of observables, for instance, comprises a plurality of point observations of one or more road boundaries of the road intersection, and the plurality of point observations are collected using one or more sensors of at least one vehicle traveling in the road intersection. The method also comprises processing the plurality of point observations to generate a triangular mesh to represent a surface of the road intersection. The triangular mesh comprises a plurality of triangles connecting the plurality of point observations as respective vertices of a plurality of triangles. The method further comprises selecting one or more branch triangles of the plurality of triangles. The vertices of the one or more triangles reference three different road boundaries of the road intersection. The method further comprises automatically detecting and/or characterizing the road intersection based on the one or more branch triangles. The method further comprises storing the detected road intersection as a data record of a geographic database, and/or providing the detected road intersection as an output.

According to another embodiment, an apparatus comprises at least one processor, and at least one memory including computer program code for one or more computer programs, the at least one memory and the computer program code configured to, with the at least one processor, cause, at least in part, the apparatus to determine a set of observables associated with a road intersection. The set of observables, for instance, comprises a plurality of point observations of one or more road boundaries of the road intersection, and the plurality of point observations are collected using one or more sensors of at least one vehicle traveling in the road intersection. The apparatus is also caused to process the plurality of point observations to generate a triangular mesh to represent a surface of the road intersection. The triangular mesh comprises a plurality of triangles connecting the plurality of point observations as respective vertices of a plurality of triangles. The apparatus is further caused to select one or more branch triangles of the plurality of triangles. The vertices of the one or more triangles reference three different road boundaries of the road intersection. The apparatus is further caused to automatically detect and/or characterize the road intersection based on the one or more branch triangles. The apparatus is further caused to store the detected road intersection as a data record of a geographic database, and/or provide the detected road intersection as an output.

According to another embodiment, a non-transitory computer-readable storage medium carries one or more sequences of one or more instructions which, when executed by one or more processors, cause, at least in part, an apparatus to determine a set of observables associated with a road intersection. The set of observables, for instance, comprises a plurality of point observations of one or more road boundaries of the road intersection, and the plurality of point observations are collected using one or more sensors of at least one vehicle traveling in the road intersection. The apparatus is also caused to process the plurality of point observations to generate a triangular mesh to represent a surface of the road intersection. The triangular mesh comprises a plurality of triangles connecting the plurality of point observations as respective vertices of a plurality of triangles. The apparatus is further caused to select one or more branch triangles of the plurality of triangles. The vertices of the one or more triangles reference three different road boundaries of the road intersection. The apparatus is further caused to automatically detect and/or characterize the road intersection based on the one or more branch triangles. The apparatus is further caused to store the detected road intersection as a data record of a geographic database, and/or provide the detected road intersection as an output.

According to another embodiment, an apparatus comprises means for determining a set of observables associated with a road intersection. The set of observables, for instance, comprises a plurality of point observations of one or more road boundaries of the road intersection, and the plurality of point observations are collected using one or more sensors of at least one vehicle traveling in the road intersection. The apparatus also comprises means for processing the plurality of point observations to generate a triangular mesh to represent a surface of the road intersection. The triangular mesh comprises a plurality of triangles connecting the plurality of point observations as respective vertices of a plurality of triangles. The apparatus further comprises means for selecting one or more branch triangles of the plurality of triangles. The vertices of the one or more triangles reference three different road boundaries of the road intersection. The apparatus further comprises means for automatically detecting and/or characterizing the road intersection based on the one or more branch triangles. The apparatus further comprises means for storing the detected road intersection as a data record of a geographic database, and/or means for providing the detected road intersection as an output.

According to one embodiment, a method comprises generating a first triangular mesh based on a plurality of point observations of one or more boundaries of the road intersection, and a second triangular mesh based on a mapped representation of the road intersection determined from a geographic database. The method also comprises selecting at least one first branch triangle from the first triangular mesh. The vertices of the at least one first branch triangle reference three different road boundaries of the one or more road boundaries. The method further comprises selecting at least one second branch triangle from the second triangular mesh. The vertices of the at least one second branch triangle reference three different mapped road boundaries of the mapped representation. The method further comprises marking the map representation as meeting an accuracy threshold (e.g., capable of supporting autonomous driving) and/or updating the mapped representation in the geographic database based on a comparison of the at least one first branch triangle and the at least one second branch triangle.

According to another embodiment, an apparatus comprises at least one processor, and at least one memory including computer program code for one or more computer programs, the at least one memory and the computer program code configured to, with the at least one processor, cause, at least in part, the apparatus to generate a first triangular mesh based on a plurality of point observations of one or more boundaries of the road intersection, and a second triangular mesh based on a mapped representation of the road intersection determined from a geographic database. The apparatus is also caused to select at least one first branch triangle from the first triangular mesh. The vertices of the at least one first branch triangle reference three different road boundaries of the one or more road boundaries. The apparatus is further caused to select at least one second branch triangle from the second triangular mesh. The vertices of the at least one second branch triangle reference three different mapped road boundaries of the mapped representation. The apparatus is further caused to mark the mapped representation as meeting an accuracy threshold (e.g., capable of supporting autonomous driving) and/or update the mapped representation in the geographic database based on a comparison of the at least one first branch triangle and the at least one second branch triangle.

According to another embodiment, a non-transitory computer-readable storage medium carries one or more sequences of one or more instructions which, when executed by one or more processors, cause, at least in part, an apparatus to receive a first input specifying ground truth data indicating one or more ground truth locations of one or more map features. The apparatus is also caused to generate a first triangular mesh based on a plurality of point observations of one or more boundaries of the road intersection, and a second triangular mesh based on a mapped representation of the road intersection determined from a geographic database. The apparatus is also caused to select at least one first branch triangle from the first triangular mesh. The vertices of the at least one first branch triangle reference three different road boundaries of the one or more road boundaries. The apparatus is further caused to select at least one second branch triangle from the second triangular mesh. The vertices of the at least one second branch triangle reference three different mapped road boundaries of the mapped representation. The apparatus is further caused to mark the mapped representation as meeting an accuracy threshold (e.g., capable of supporting autonomous driving) and/or update the mapped representation in the geographic database based on a comparison of the at least one first branch triangle and the at least one second branch triangle.

According to another embodiment, an apparatus comprises means for generating a first triangular mesh based on a plurality of point observations of one or more boundaries of the road intersection, and a second triangular mesh based on a mapped representation of the road intersection determined from a geographic database. The apparatus also comprises means for selecting at least one first branch triangle from the first triangular mesh. The vertices of the at least one first branch triangle reference three different road boundaries of the one or more road boundaries. The apparatus further comprises means for selecting at least one second branch triangle from the second triangular mesh. The vertices of the at least one second branch triangle reference three different mapped road boundaries of the mapped representation. The apparatus further comprises means for marking the mapped representation as meeting an accuracy threshold (e.g., capable of supporting autonomous driving) and/or updating the mapped representation in the geographic database based on a comparison of the at least one first branch triangle and the at least one second branch triangle.

In addition, for various example embodiments described herein, the following is applicable: a computer program product may be provided. For example, a computer program product comprising instructions which, when the program is executed by a computer, cause the computer to perform any one or any combination of methods (or processes) disclosed.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of automated detection and/or characterization of an intersection, according to one embodiment;

FIG. 2 is a diagram illustrating real-time data pipeline for automated detection and/or characterization of an intersection, according to one embodiment;

FIG. 3 is a diagram of the components of a mapping platform configured for automated detection and/or characterization of an intersection, according to one example embodiment;

FIG. 4 is a flowchart of a process for automated detection and/or characterization of an intersection, according to one example embodiment;

FIG. 5 is a diagram illustrating an example of mesh triangulation for detecting and/or characterizing an intersection, according to one example embodiment;

FIG. 6 is a diagram illustrating an example algorithm for mesh triangulation, according to one example embodiment;

FIG. 7 is a diagram of a half edge data structure for representing and navigating through a triangular mesh, according to one example embodiment;

FIG. 8 is a diagram of example triangle types in a triangular mesh representation of an intersection, according to one example embodiment;

FIGS. 9A and 9B are diagrams of examples of filtering or selecting by triangle type in a triangular mesh representation for detection and/or characterization of an intersection, according to one example embodiment;

FIGS. 10A and 10B are diagrams of an example of using mesh triangulation to characterize entry or exit roads to an intersection, according to one example embodiment;

FIG. 11 is a diagram of an example of using mesh triangulation to characterize an extent of an intersection, according to one example embodiment;

FIG. 12 is a diagram of an example of determining travels paths through a detected intersection, according to one example embodiment;

FIG. 13 is a flowchart of a process for comparing triangular mesh representations of an intersection, according to one example embodiment;

FIGS. 14A and 14B are diagrams of an example of using measured distance to compare triangular mesh representations of an intersection, according to one embodiment;

FIG. 15 is a diagram of a geographic database, according to one embodiment;

FIG. 16 is a diagram of hardware that can be used to implement an embodiment of the invention;

FIG. 17 is a diagram of a chip set that can be used to implement an embodiment of the invention; and

FIG. 18 is a diagram of a mobile terminal that can be used to implement an embodiment of the invention.

### DESCRIPTION OF SOME EMBODIMENTS

Examples of a method, apparatus, and computer program for automated detection and characterization of a road intersection are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. In addition, the embodiments described herein are provided by example, and as such, “one embodiment” can also be used synonymously as “one example embodiment.” Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

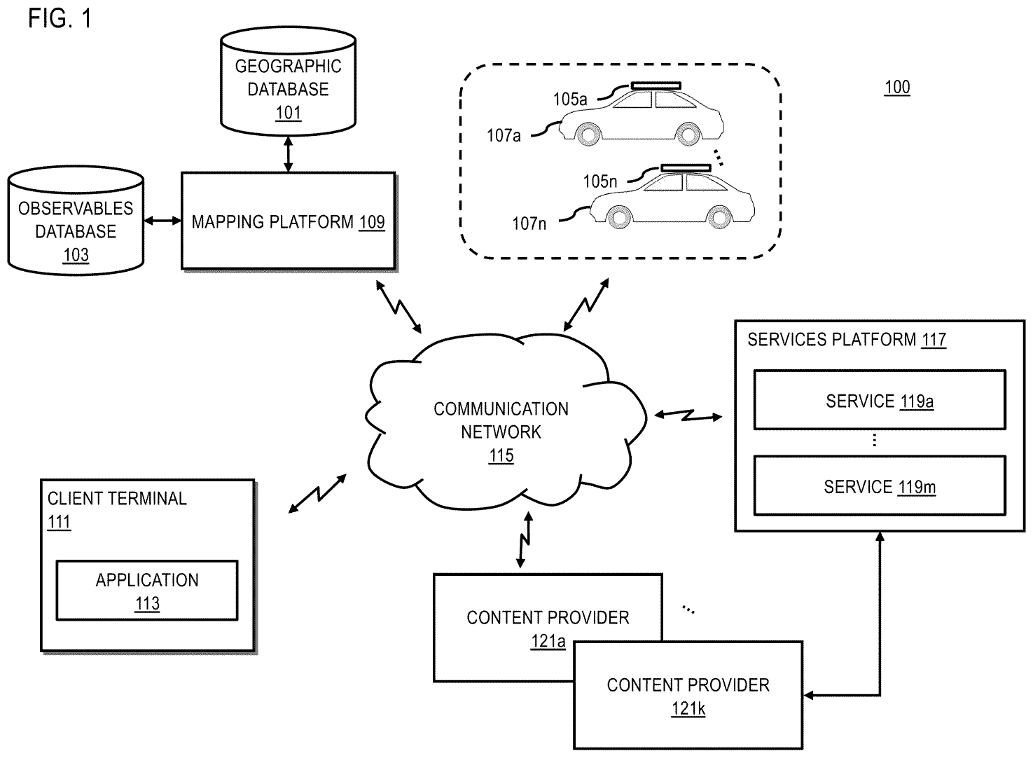

FIG. 1 is a diagram of a system 100 capable of automated detection and/or characterization of an intersection, according to one embodiment. Traditionally, digital map data (e.g., digital map data of a geographic database 101) are created and updated manually by computer operators using data (e.g., observable data stored in an observables database 103) collected from sensors 105a-105n (also collectively referred to as sensors 105) on vehicles 107a-107n (also collectively referred to as vehicles 107) and/or other remote sensing devices (e.g., airplanes, drones, satellites, consumer devices, etc.) using computer based tools (e.g. provided by a mapping platform 109). The traditional approaches to digital map making face significant technical challenges to achieve levels of detail and accuracy required by autonomous/self-driving vehicles and other equivalent advanced location-based applications or services. The need for high detail and accuracy (e.g., meter or sub-meter accuracy) is particularly acute at intersections where roads or other paths cross or meet, thereby increasing the potential for collisions with other vehicles, people, etc. in the intersection.

It is common to have a digital representation of a routing network for the purpose of in vehicle navigation. Generally, the routing network map is not geometrically accurate enough, nor does it have lane level detail for controlling vehicle maneuvers in autonomous vehicle applications. However, the network of intersections and road links is accurate and can be used as a starting point for further geometric and lane level precision and adjustments.

To achieve the levels of detail and accuracy required by advanced applications such as autonomous driving, traditional mapping service providers often rely on manually synthesizing the current map data (e.g., currently mapped features in the geographic database 101) and sensor data captured of reference objects in the field (e.g., observables collected and stored in the observables database 103). By way of example, digital map data generally consists of lower resolution maps (e.g., approximately 10 m accuracy) that represent map features using a node and link representation with attributes. The node and link representation form a network graph to represent a road network. Generally, traditional map data is accurate for vehicle routing but is not accurate enough for autonomous vehicles or similar applications, for instance, because their lower accuracy does not support vehicle drive paths within lanes. On the other hand, sensor data or sensor derived data are collected using sensors (e.g., sensors 105) in vehicles, satellites, etc. and offer higher accuracy (e.g., lane level or better accuracy) than traditional map data (e.g., 10 m accuracy). By way of example, sensor data can include data output (e.g., referred to herein as observables) from cameras, LiDAR, and/or other equivalent sensors indicating detectable features such as, but not limited to, road boundaries, lane boundary markings (e.g., solid and dashed), crosswalks, road signs, road markings (e.g., turn arrows), etc. Because these features are at fixed locations, their locations can be determined with high accuracy (e.g., meter or sub-meter accuracy) and often act as “ground truth” locations. However, as indicated above, fusing the traditional map data and sensor data has traditionally been a manual process that does not scale well when mapping large geographic areas.

In other words, manual updates are very expensive and time consuming and prone to error. For example, traditional lane or road detection algorithms generate lanes, roads, road boundaries, etc. from observable data but primarily only for linear stretches of road between intersections. There have been historical attempts to detect lanes, roads, road boundaries, etc. in intersections, but the detection process works only if there are lane markings in intersections, which is uncommon for many intersections. Other traditional approaches include manual tools used to edit roads and lanes. These tools, for instance, employ a heuristic method to generate lanes inside an intersection from the roads and lanes entering an intersection but do not account for observable geometry (polylines) surrounding the intersection. Therefore, mapping service providers face significant technical challenges with respect to replacing traditional manual map making approaches with more automated processes.

To address these technical challenges, the system 100 of FIG. 1 introduces a capability to detect and/or characterize an intersection using mesh triangulation so that the intersection can be added or updated to digital map data (e.g., digital map data of the geographic database 101). In one embodiment, the mesh triangulation generates a representation of an intersection as a mesh of connected triangles following the boundaries of surfaces of the roadways of the intersection as detected by sensor data (e.g., observation points stored in the observables database 103). In other words, the mesh represents a two-dimensional manifold of the surfaces of the roadways of the intersection. Because the sensor data points from which the triangular mesh is generated can detect features (e.g., road boundaries of the intersection) with high accuracy (e.g., meter or sub-meter accuracy), the resulting detection of the intersection will also have this high accuracy that is sufficient support applications such as but not limited to autonomous or semi-autonomous vehicle operation.

As used herein, the term “triangulation” refers to a process by which the mapping platform 109 creates triangular mesh representation of an intersection's surface by dividing it into smaller regions that are approximated by triangles. The triangular mesh representation advantageously facilitates representation and processing of the represented surface using automated means (e.g., a computer-implemented algorithm) to detect and/or characterize intersections. Detecting refers to identifying the presence of an intersection and characterizing refers to identifying characteristics of the intersection (e.g., extent, width, number of entry/exit roadways, etc.). For example, the mesh triangulation can be used to capture or determine the elevation, slope, curvature, width, etc. of a road as well as boundaries and other features of the road.

In one embodiment, the mesh triangulation is performed using Delaunay triangulation. Delaunay triangulation creates a triangular mesh from a set of points (e.g., observations points corresponding to road boundaries as collected and stored in the observables database 103) in any number of dimensions (e.g., two- or three-dimensional space). Delaunay triangulation has the property that no point is inside the circumcircle of any triangle in the mesh. Because of this, the Delaunay triangulation mesh is independent of orientation if the relative positions of the observation points or vertices are in the same relative position. In other words, since the Delaunay mesh is independent of the reference coordinate system, the resulting topology or connections to the road boundary are the same regardless of the sensor orientation. This property of Delaunay meshes advantageously facilitates automated comparison of different triangular meshes regardless of differences in their orientation. Therefore, in one embodiment, triangular meshes can be made of the same intersection from different point sources. For example, when using sensor data as one point source and current map data as another point source, the intersection data in the current map data can be compared against sensor data of the same intersection to determine whether the current map data is capable of supporting high accuracy applications like autonomous driving or whether the current map data for the intersection should be updated with the higher accuracy sensor data representation.

It is noted that although the various embodiments described herein are discussed with respect to road intersections, it is contemplated that the embodiments are also applicable to any type of intersection of any type of travel paths (e.g., pedestrian paths, bicycle paths, waterways, etc.) alone or in any combination with vehicle roadways.

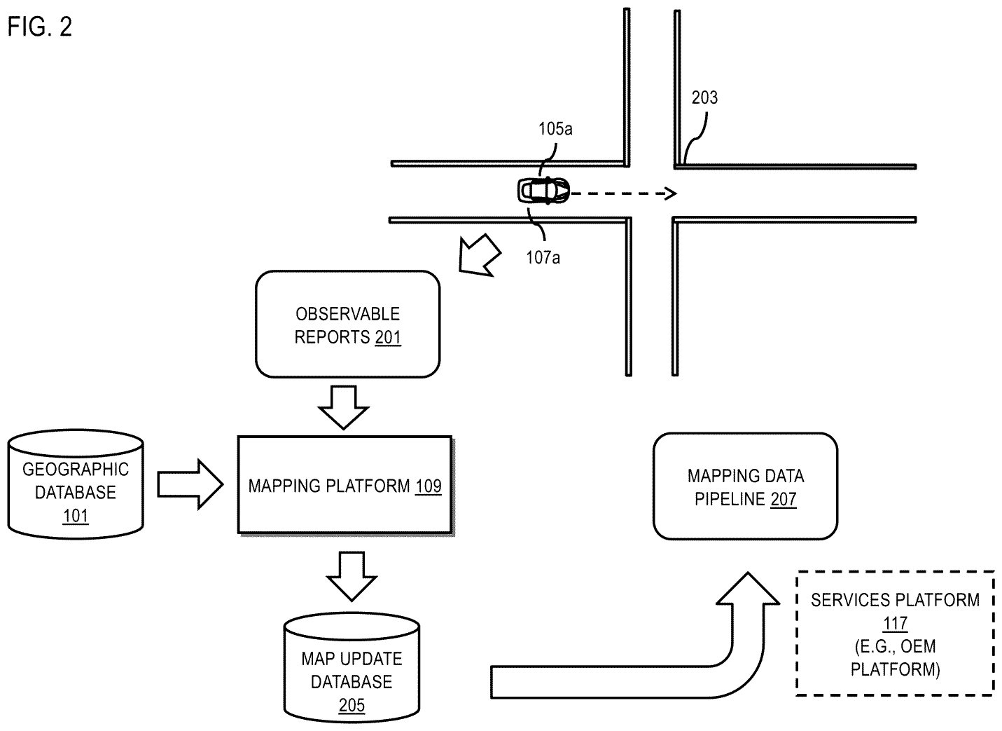

FIG. 2 is a diagram illustrating real-time data pipeline for automated detection and/or characterization of an intersection, according to one embodiment. In one embodiment, the process for detecting and/or characterizing intersections using mesh triangulation can be performed as part of an automated mapping pipeline as shown in FIG. 2. Automated refers, for instance, to operating the pipeline without manual intervention in all or a portion of the pipeline from data ingestion to output of the resulting intersection map data. Thus, the various embodiments described herein provide technical improvements to the map making pipeline or system 100 by introducing a triangular mesh representation and algorithms/systems for processing the triangular mesh representation to detect and/or characterize intersections. As shown, the mapping platform 109 receives observable reports 201 (e.g., sensor data reports that include detected road boundaries of an intersection 203 from a vehicle 107a equipped with sensors 105a) as the vehicle 107a travels through the intersection 203. The observable reports 201 include point locations (e.g., sampled at a configured distance interval such as but not limited to every 0.5 m) where a respective road boundary or equivalent feature was detected by its sensors.

In the case of observables generated from satellite or aerial imagery, the imagery can be processed (e.g., using object recognition/image processing systems) to detect road boundaries of the intersection at configured sampling intervals. The sampling intervals, for instance, can be set to provide for uniform spacing of triangles such that the resulting triangles of the Delaunay mesh are sized so that they can represent a minimum feature size of the intersection or roadway. In one embodiment, the road boundaries are detected and represented as polylines (e.g., a connected sequence of location or observation points where a road boundary was detected).

In yet another embodiment, road boundaries and lane markings can be represented by a geographic vector valued function:

\vec{F}(t)_{ϕ,λ,z}

Where ϕ=latitude, λ=longitude and z=altitude.

For a normalized function, \vec{F}(t), 0≤t≤1. If the function is arc length parameterized, then the curve length measured between two different values of the parameter t are exactly proportional to the total length of the curve. The function \vec{F}(t)_{ϕ,λ,z} can be a piecewise linear curve or a Bezier spline or any other parameterizable function. Typically, road boundaries and lane markings from observation such as satellite imaging and in-vehicle cameras produce geometric points in a sequence which, when connected together represent a continuous curve. Each point can vary in distance for adjacent points. A second representation is used for easy derivation which is a NURB, or Non-uniform Rational B-Spline. In one embodiment, the system can sample each curve which represents a boundary evenly distributed so that:

$$\vert \vec{F} ( {t}_{i + 1} ) - \vec{F} ( {t}_{i} ) \vert = {k}_{i} for i = 0 , n and {\sum }_{0}^{i - 1} {k}_{i} = L$$

Are equal for all values of i which represent the total samples which match the length of the curve L. To make this possible, \vec{F}(t), can be in projected cartesian coordinates. In some embodiments, a Mercator projection can be used.

The mapping platform 109 aggregates and analyzes the observable reports 201 (e.g., from one or more vehicles 107) to detect and/or characterize the intersection 203 based on mesh triangulation according to the various embodiments described herein. In one embodiment, the detected and/or characterized intersections can be stored directly in the geographic database 101. In addition or alternatively, the detected and/or characterized intersections can be stored in a map update database 205 which can then be processed through an existing mapping data pipeline 207 before being published to the geographic database 101 and/or provided as an output (e.g., to end users such as autonomous vehicles or other mapping/navigation services users). In one embodiment, the observable reports 201 and/or map update database 205 derived therefrom can be optionally collected by a services platform 117 (e.g., a platform operated by an automobile original equipment manufacturer (OEM) to collect and process data from its fleet of cars) and then provided from the services platform 117 to the mapping data pipeline 207. The mapping data pipeline 207, for instance, can further process, verify, format, etc. the detected and/or characterized intersection data before publication or updating of the official digital map data of the geographic database 101.

In one embodiment, the mapping platform 109 can use any architecture for transmitting the observable reports 201, intersection data, and/or related information to the end user devices (e.g., the vehicle 107a, client terminal 111 executing a client application 113, etc.) over a communication network 115. In one embodiment, the mapping platform 109 can also transmit or publish the intersection data to a third-party services platform 117, any services 119a-119m (also collectively referred to as services 119) of the services platform 117, one or more content providers 121a-121k (also collectively referred to as content providers 121). When performing direct publishing, the transmission of the intersection data is performed over the communication network 115 between the mapping platform 109 and one or more user devices (e.g., the vehicles 107, client terminal 111, etc.) directly. When publishing via a third-party, the transmission of the intersection data is performed over the communication network 115 between the mapping platform 109 and a third-party provider such as the services platform 117 (e.g., a vehicle OEM platform), services 119, and/or content providers 121.

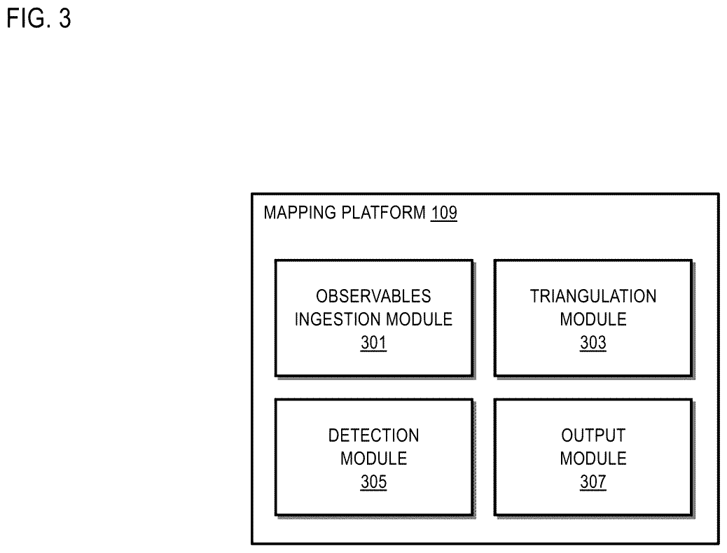

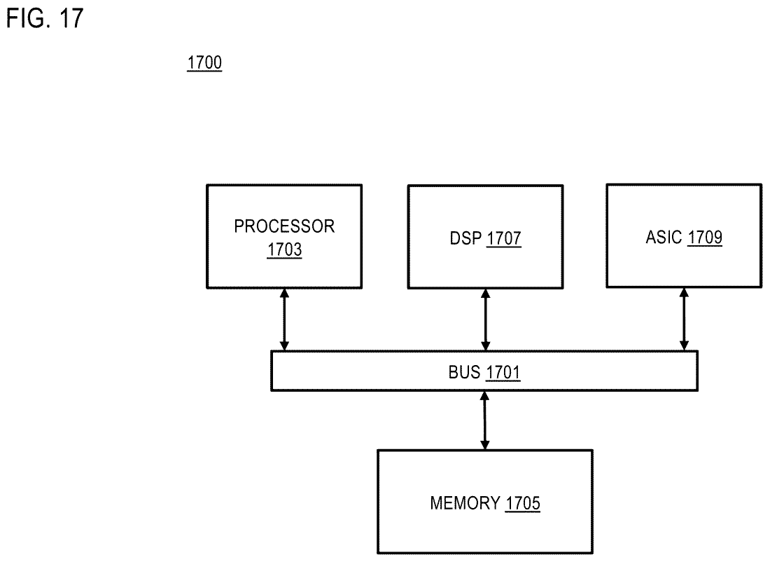

FIG. 3 is a diagram of the components of the mapping platform 109 configured for automated detection and/or characterization of an intersection, according to one example embodiment. By way of example, the mapping platform 109 includes one or more components for detecting and/or characterizing intersections according to the various embodiments described herein. It is contemplated that the functions of these components may be combined or performed by other components of equivalent functionality. In one embodiment, the mapping platform 109 includes an observables ingestion module 301, a triangulation module 303, a detection module 305, and an output module 307. The above presented modules and components of the mapping platform 109 can be implemented in hardware, firmware, software, or a combination thereof such as but not limited to the hardware illustrated in FIGS. 17-19. Though depicted as a separate entity in FIG. 1, it is contemplated that the mapping platform 109 may be implemented as a module of any of the components of the system 100 (e.g., a component of the vehicle 107, services platform 117, services 119, content providers 121, client terminal 111, application 113, etc.). In another embodiment, one or more of the modules 301-307 may be implemented as a cloud based service, local service, native application, or combination thereof. The functions of the mapping platform 109 and the modules 301-307 are discussed with respect to FIGs. below.

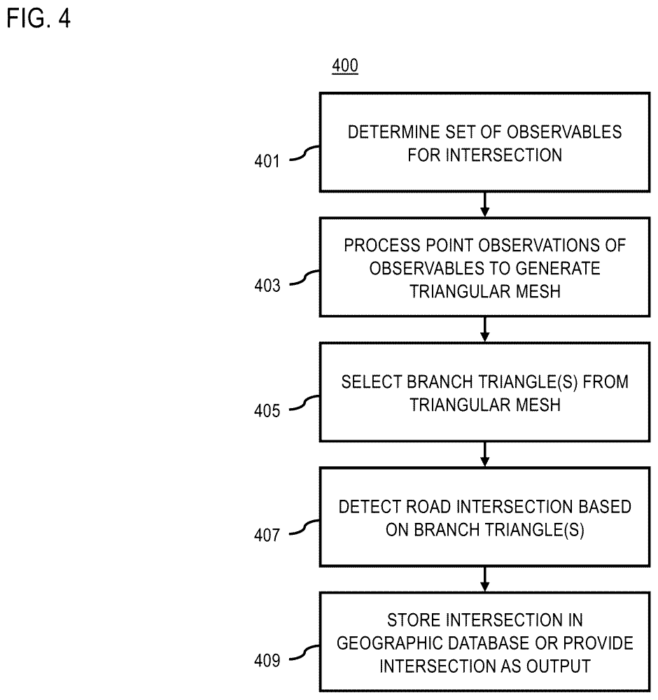

FIG. 4 is a flowchart of a process 400 for automated detection and/or characterization of an intersection, according to one example embodiment. In various embodiments, the mapping platform 109 and/or any of the modules 301-307 of the mapping platform 109 may perform one or more portions of the process 400 and may be implemented in, for instance, a chip set including a processor and a memory as shown in FIG. 17 or in circuitry, hardware, firmware, software, or in any combination thereof. As such, the mapping platform 109 and/or the modules 301-307 can provide means for accomplishing various parts of the process 400, as well as means for accomplishing embodiments of other processes described herein in conjunction with other components of the system 100. Although the process 400 is illustrated and described as a sequence of steps, it is contemplated that various embodiments of the process 400 may be performed in any order or combination and need not include all of the illustrated steps.

In step 401, the observables ingestion module 301 determines, using a processor, a set of observables associated with the road intersection. In one embodiment, the set of observables comprises a plurality of point observations of one or more road boundaries of the road intersection, and the plurality of point observations are collected using one or more sensors of at least one vehicle traveling in the road intersection. Each observable and/or observation point of the observable can be associated with (e.g., via metadata or equivalent) to a corresponding road boundary of the intersection. This enables the mapping platform 109 to group or identify which road boundary each observation point represents. In one embodiment, the plurality of point observations is sampled at a designated distance interval (e.g., every 0.5 m or any other specified interval). This sampling (or resampling) of the observations can be used to normalize the sizes of the bases of the triangles from subsequent mesh triangulation. In one embodiment, the point observations are stored in a sequence indicating a start and end to the road boundary in order.

As discussed above, observables (e.g., observable reports 201) are based on sensor data. For example, sensors 105 (e.g., cameras, LiDAR, etc.) mounted on vehicles 107 traveling on roads of the intersection as well as on remote sensing vehicles of devices (e.g., satellites, airplanes, drones, etc.) detect road boundaries and can represent them as a series of points forming a polyline, a piecewise linear curve called an observable. The points of the polyline are also referred to herein as observations points of the observable. Under an ideal situation, a road will have two road boundaries on each side that continue the full length of the road and do not have any discontinuities. When a road connects to two or more roads, it is considered an intersection. An intersection will have three or more road boundaries surrounding it in different shapes, depending on the extent of the turning lanes and other factors. Thus the observables determined in this step can include observation points corresponding to detected locations of the road boundaries of the intersection. Multiple observables from multiple vehicles 107 can be determined or received by the observable ingestion module 301 to obtain a complete representation of an intersection.

In step 403, the triangulation module 303 processes, using a processor, the plurality of point observations (e.g., in the observables determined in step 401) to generate a triangular mesh to represent a surface of the road intersection. The triangular mesh, for instance, comprises a plurality of triangles connecting the plurality of point observations as respective vertices of the plurality of triangles. In one embodiment, the triangular mesh is generated so that no vertex of the plurality of triangles falls in the interior of a circumcircle of any triangle of the plurality of triangles.

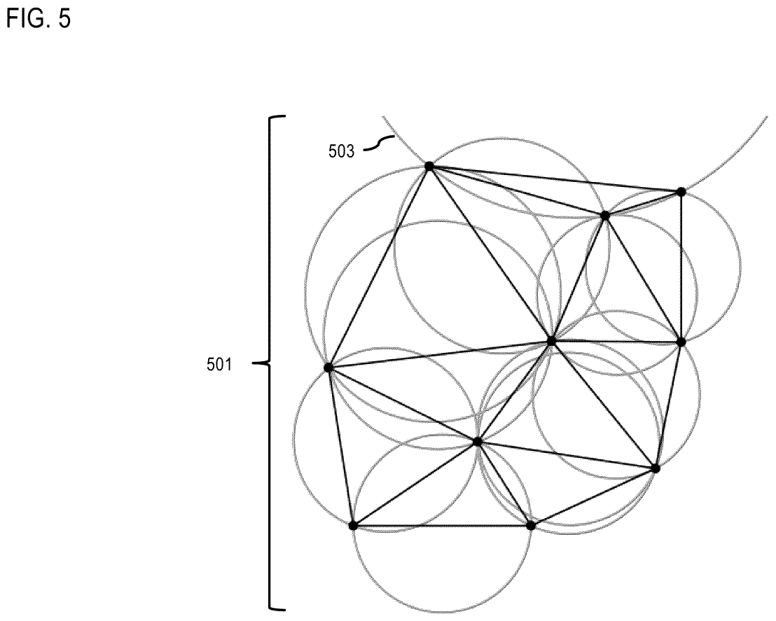

More specifically, in one embodiment, the triangular mesh is generated using Delaunay triangulation to detect and/or characterize road intersections by using the set of determined observation points of the observables. FIG. 5 is a diagram illustrating an example of mesh triangulation for detecting and/or characterizing an intersection using Delaunay triangulation, according to one example embodiment. A Delaunay triangulation 501 of a vertex set (e.g., illustrated as black points in FIG. 5) is a triangulation of the vertex set with the property that no vertex in the vertex set falls in the interior of the circumcircle 503 of any triangle in the triangulation. A circumcircle is a circle that passes through all three vertices of a triangle. The mesh triangulation (e.g., Delaunay triangulation) of the various embodiments described herein can occur in any number of dimensions. For two-dimensions, mesh triangulation forms triangles. For three-dimensions, mesh triangulation forms tetrahedrons which form circumspheres with no interior points over the volume. In one embodiment, for the application of road intersections, two-dimensional triangles are used and form a two-dimensional manifold such that triangle edges are shared by only one or two triangles. If an edge is shared by only one triangle, it is referred to as a free edge. As previously discussed, triangulation in which no vertex in the vertex set falls in the interior of the circumcircle which passes thru all three vertices of any triangle in the triangulation (e.g., Delaunay triangulation) is unique and independent of scale and orientation when the mesh triangulation is continuously connected with no gaps.

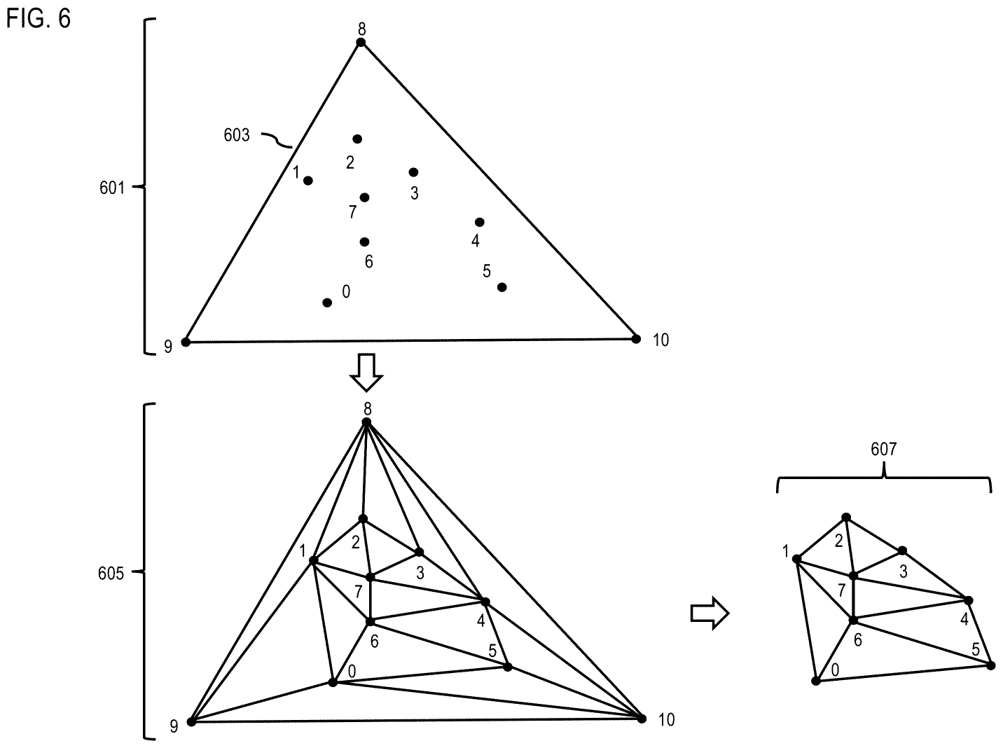

FIG. 6 is a diagram illustrating an example algorithm for mesh triangulation, according to one example embodiment. In one embodiment, the mesh triangulation algorithm is implemented as an automated process of the triangulation module 303. The mesh algorithm begins with a cloud of points (e.g., observation points of road boundaries determined from step 401 above) which, after completion, connects all the points as vertices of triangles satisfying the Delaunay triangulation described above. The initial step is to determine the extent of the cloud 601 of points (e.g., points 0-10 in this example) and create a single triangle 603 which encloses the cloud 601 with vertices corresponding to the three outer most points 8, 9, and 10.

The points 0-10 of the cloud 601 are then connected into vertices of triangles beginning with the initial triangle 603, each being tested for points laying inside and creating the smallest circumcircle which does not contains any other points. The result is shown as an initial triangular mesh 605. Once the initial mesh 605 is complete, the triangulation module 303 deletes all triangles which connect to the initial, outer vertices (e.g., corresponding to points 8, 9, and 10) of the triangle 603 to generate the resulting triangular mesh 607. The resulting triangular mesh 607 (e.g., a Delaunay mesh) has a special property which produces the identical mesh independent of the orientation or scale. As long as the original points 0-10 in the cloud 601 have the same relative position to each other, the resulting mesh 607 is identical. This property of the mesh 707 can be used for comparing point clouds from different sources which have slightly different orientations.

In one embodiment, the mapping platform 109 can use a half-edge data structure while performing the mesh triangulation above to help efficiently navigate through the resulting triangular mesh. While face-based data structures store their connectivity in faces referencing their vertices and neighbors, edge-based data structures put the connectivity information into the edges. In edge-based data structure, each edge references its two vertices, the faces it belongs to and the two next edges in these faces. If the edges (i.e., an edge connecting vertex A and vertex B becomes two directed half-edges from A to B and vice versa) are now split, the result is a half-edge data structure.

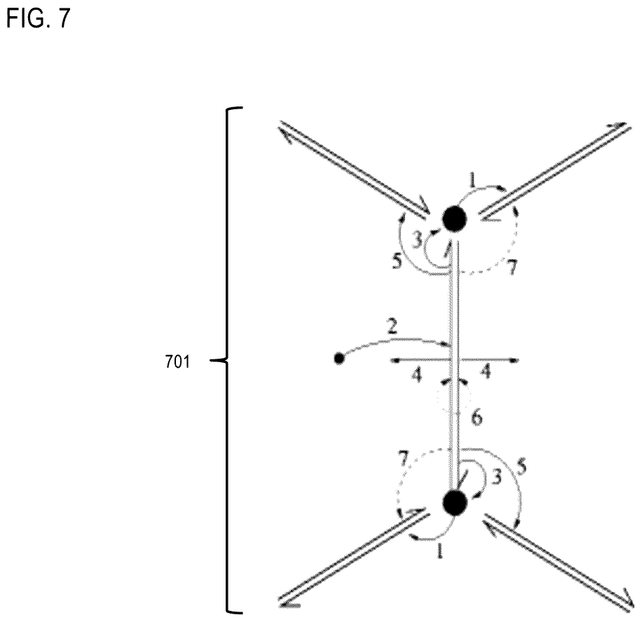

FIG. 7 is a diagram of a half edge data structure 701 for representing and navigating through a triangular mesh, according to one example embodiment. As shown in FIG. 7, in the half-edge data structure 701, each vertex references one outgoing half-edge, e.g., a half-edge that starts at this vertex (1). Each face references one of the half-edges bounding it (2). Each half-edge provides a handle to:
The vertex it points to (3),
The face it belongs to (4).
The next half-edge inside the face (ordered counterclockwise) (5),
The opposite half-edge (6), and
(Optionally: the previous half-edge in the face (7)).

Having these links between the items, it is now possible to circulate around a face in order to enumerate all its vertices, half-edges, or neighboring faces. When starting at a vertex's half-edge and iterating to the opposite of its previous one, one can easily circulate around this vertex and get all its one-ring neighbors, the incoming/outgoing half-edges, or the adjacent faces.

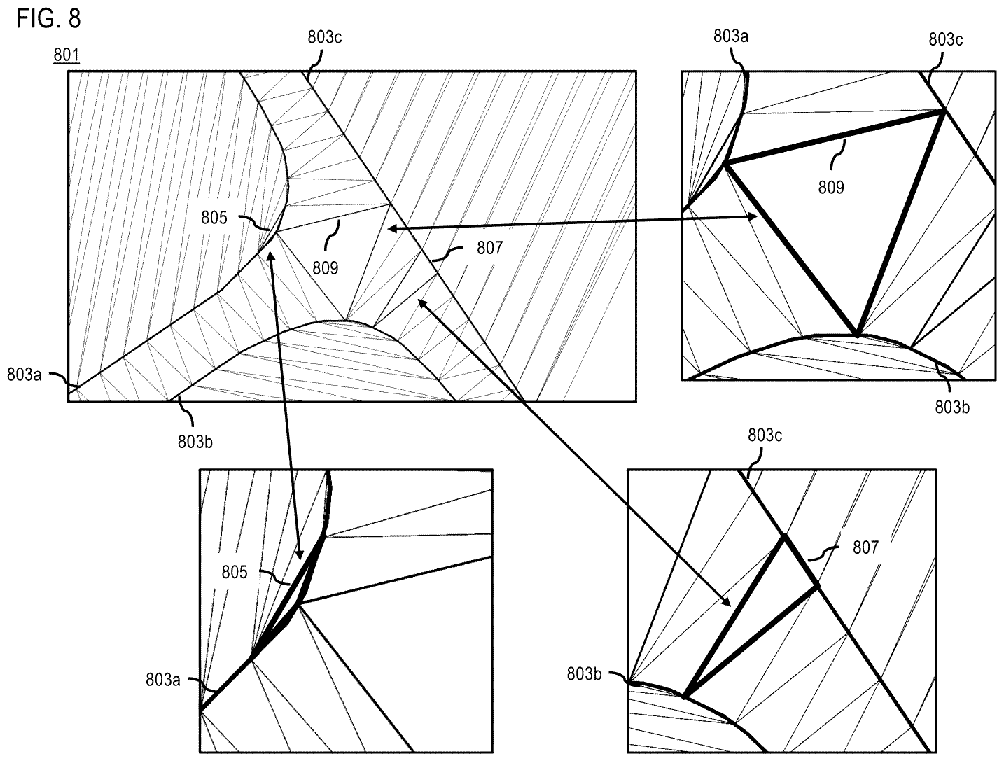

FIG. 8 is a diagram of example triangle types in a triangular mesh representation of an intersection, according to one example embodiment. Detecting and/or characterizing a road intersection based on its boundaries can be performed using a triangular mesh (e.g., a Delaunay mesh). In one embodiment, by sampling each road boundary on an intersection at observation points separated by a constant length (e.g., regular distance intervals such as but not limited to 0.5 m), the triangular mesh 801 can be produced where the vertices of each triangle in triangular mesh 801 falls a respective road boundaries 803a-803c of the intersection. In this example, the intersection is a three-way intersection in which there are three road boundaries 803a-803c.

There are three possible triangles produced when meshing independent road boundaries surrounding an intersection: (1) a “depression” triangle, (2) a “bridge” triangle, and (3) a “branch” triangle. Each triangle type is classified by the number of different road boundaries that the triangle references. The number of different road boundaries “referenced” by a triangle refers to the number of different road boundaries on which the respective vertices (e.g., corresponding to respective road boundary observation points) is located. As shown in FIG. 8, a depression triangle 805 references just a single road boundary 803a (e.g., all three vertices of the depression triangle are located on the same road boundary 803a). A bridge triangle 807 references only two different road boundaries 803b and 803 (e.g., two vertices of the triangle 807 are located on boundary 803b, and a third vertex is located on boundary 803c). A branch triangle 809 references three different boundaries 803a-803c (e.g., a first vertex of the triangle 809 is located on boundary 803a, a second vertex is located on boundary 803b, and a third vertex is located on boundary 803c). It is noted that a triangle cannot reference more than three boundaries because it includes only three vertices.

In step 405, as part of intersection detection and/or characterization, the detection module 305 selects, using a processor, one or more branch triangles of the plurality of triangles as an indicator of an intersection. As described above, the vertices of the one or more branch triangles reference three different road boundaries of the road intersection. In other words, the detection module 305 filters all the depression and bridge triangles of the triangular mesh of the road intersection to leave only the branch triangles.

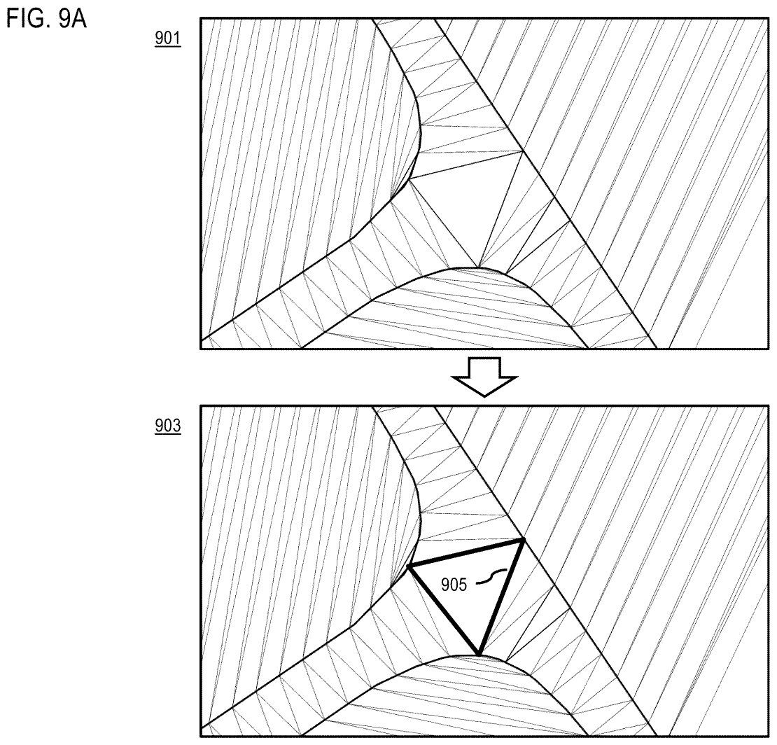

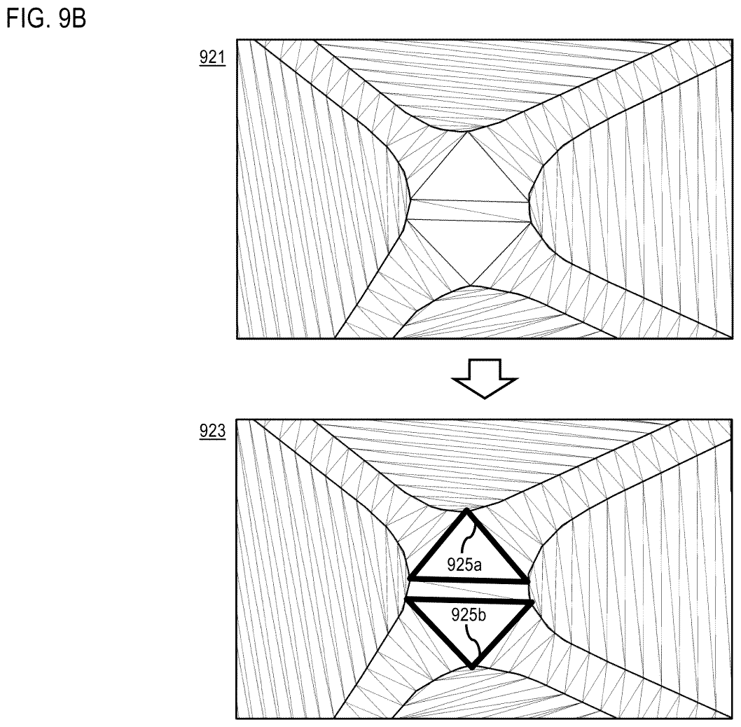

FIGS. 9A and 9B are diagrams of examples of filtering or selecting by triangle type in a triangular mesh representation for detection and/or characterization of an intersection, according to one example embodiment. FIG. 9A is an example of a triangular mesh 901 that represents a three-way intersection comprising the full complement of triangle types (e.g., depression, bridge, and branch triangles). Filtering out the depression and bridge triangles from the triangular mesh 901 results in filtered triangular mesh 903 that contains a single branch triangle 905. In other words, the filtered triangular mesh 903 hides all triangles but the branch triangle 905. FIG. 9B is a similar example of a triangular mesh 921 that represents a four-way intersection as opposed to the three-way intersection example of FIG. 9A. As with the full complement of triangle types is represented in the triangular mesh 921. Filtering out the depression and bridge triangles from the triangular mesh 921 results in filtered triangular mesh 923 to leave two branch triangles 925a and 925b.

In step 407, the detection module 305 automatically detects, using a processor, the road intersection based on the one or more branch triangles of the triangular mesh representation of the intersection. In other words, the detection module 305 uses the presence of one or more branch triangles as a proxy for indicating the presence of an intersection. Thus, the use of a triangular mesh representation of an intersection to detect the presence of an intersection more easily by enabling a detection module 305 to simply perform a filtering operation for branch triangles.

In one embodiment, the detection module 305 can characterize various attributes of the intersection using the branch triangles or the triangular mesh. For example, a location of the intersection can be determined based on the location of the branch of triangle such as by taking a centroid (or any other designated location) of the one or more branch triangles as the location of the intersection. For example, the centroid a triangle is the point where the three medians (lines connecting a vertex to the midpoint of the opposite side) intersect. In the case of more than one branch triangle, the detection module 305 can calculate the weighted average of the centroids of all triangles to find the centroid of the entire group of multiple branch triangles with the weight of each triangle being proportional to its area. The above examples of the finding the centroid of one or more branch triangles are provided by way of illustration and not as limitations. It is contemplated that equivalent process or algorithm can be used according to the various embodiment described herein.

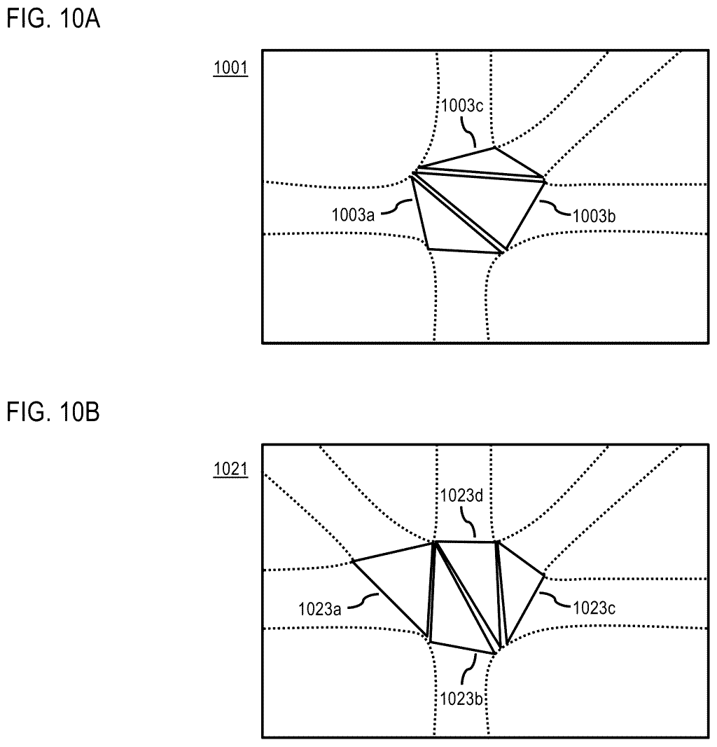

In one embodiment, the detection module 305 can determine the number of entry or exit roads of the road intersection based on the number of the one or more branch triangles selected from the triangular mesh. For each new road that enters the intersection, a new branch triangle is created. For example, as shown in the filtered triangular mesh 903 of FIG. 9A, a three-way intersection has a single branch triangle 905 while the filtered triangular mesh 923 of FIG. 9B shows that a four-way intersection has two branch triangles 1025a and 1025b. FIGS. 10A and 10B show the continuation of this correlation of number of entry/exit roads with the number of branch triangles of an intersection. For example, FIG. 10A illustrates a filtered triangular mesh 1001 of a five-way intersection that has three branch triangles 1003a-1003c, and FIG. 10B illustrates a filtered triangular mesh 1021 of a six-way intersection that has four branch triangles 1023a-1023d. The relationship between the number of entry/exit roads to the number branch triangles in the triangular mesh of the corresponding intersection is that the number of entry/exit roads is equal to the number of branch triangles plus two.

In addition or alternatively, the entry or exit roads can be detected based on one or more free edges of the one or more branch triangles. A free edge, for instance, refers to an edge of the branch triangle that is not adjacent to an edge of any other triangle in the filtered mesh representation of an intersection. In other words, branch triangles indicate entry/exit to the intersection and each road entering or exiting an intersection are marked at the correct location by the branch triangle (e.g., at a corresponding free edge).

In one embodiment, the detection module 305 determines an extent of the road intersection based on a position where an entry or exit road of the road intersection starts to widen by starting at a free edge of the one or more branch triangles, and following one or more bridge triangles of the triangular mesh along the entry or exit road until a width of the entry or exit road remains constant within a threshold value. As discussed above, vertices of the one or more bridge triangles reference exactly two different road boundaries of the road intersection. As used herein, the “extent” of an intersection refers to where the intersection is defined to begin and end within a road network. The determined extent of the intersection can then be used to adjust the representation of the intersection in the digital map data.

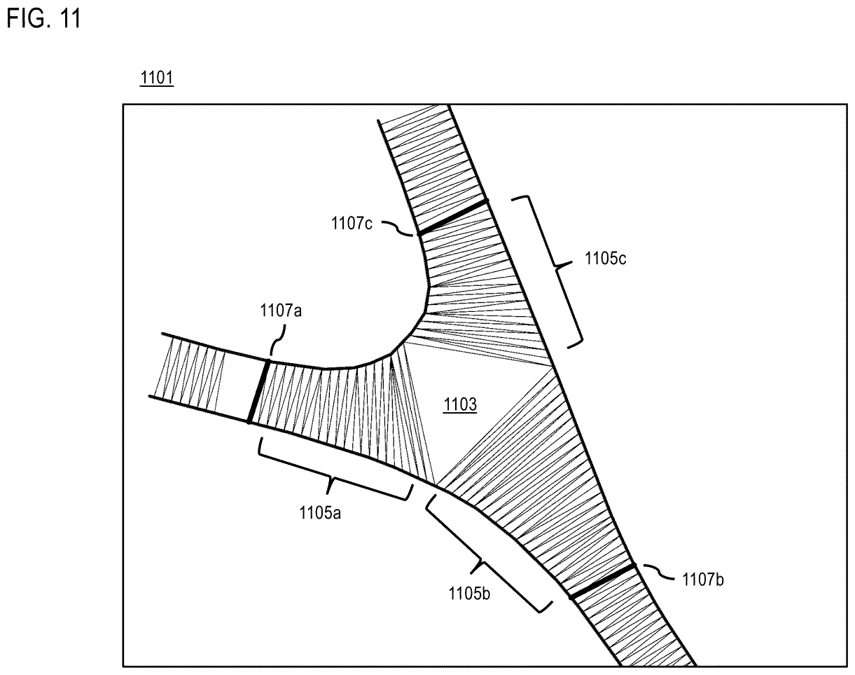

FIG. 11 is a diagram of an example of using mesh triangulation to characterize an extent of an intersection, according to one example embodiment. In one embodiment, the beginning of an intersection is defined as a part of the road that starts to widen beyond its standard width on approach to the intersection. For example, the widening can be an indication of the presence of a turning lane of the intersection starts to form. Similarly, the end of the intersection can be determined based on where the road narrows to a constant width. This narrowing can be an indication that a turning lane of the intersection is ending. As shown in the example of FIG. 11, a triangular mesh representation 1101 is generated for three-way intersection according to the various embodiments described herein. The depression triangles have been filtered to leave or select only the branch triangle 1103 and bridge triangles 1105.

To determine the extent of the three-way intersection, the detection module 305 starts from the branch 1103 and proceeds along the bridge triangles of each road entering or exiting the intersection. In this case, the detection module 305 follows along the bridge triangles 1105a until the width of the road is constant beginning at location 1107a, which can then be marked as the extent of the intersection along that road. Similarly, the detection module 305 follows along each subsequent road of the intersection to find the extent of the intersection along each road of the intersection (e.g., following bridge triangles 1105b to find the extent of the intersection at location 1107b, and following bridge triangles 1105c to find the extent of the intersection at location 1107c).

In one embodiment, the location of accessors to the road intersection is determined based on the extent (e.g., beginning or end of the intersection) of the road intersection. As used herein an accessor is to a road intersection typically refers to an entry or exit point that provides access to or from a road intersection. This accessor can be a turning lane or other designated lane of a road that allow vehicles to turn left or right at an intersection. Dedicated turning lanes allow the vehicles to turn without impeding the flow of through traffic and provide access for vehicles to enter or exit the intersection safely. These dedicated turning lanes can increase the width of the roadway near intersections and are detectable according to the process of the various embodiments described above. In this way accessors to intersections can be detected and/or characterized using mesh triangulation.

In one embodiment, the determined extent of the intersection can be used by the detection module 305 or other component to automatically detect travel paths through the intersection even if there are no lane lines or boundaries present in the intersection. For example, the detection module 305 can identify a set of lane traversals for a road intersection. The set of lane traversals may be produced by associating one or more inbound lanes of the road intersection with one or more outbound lanes of the road intersection to define paths of travel from the inbound lanes to the outbound lanes of each of the roads entering or exiting the intersection. The detection module 305 or other component of the mapping platform 109 can compute respective safety-traffic flow scores for each of the possible travel paths to identify the paths that have a higher probability of representing actual travel paths through the intersection. The starting and ending points of the travel paths can be configured to start or end at the detected extents of the intersection.

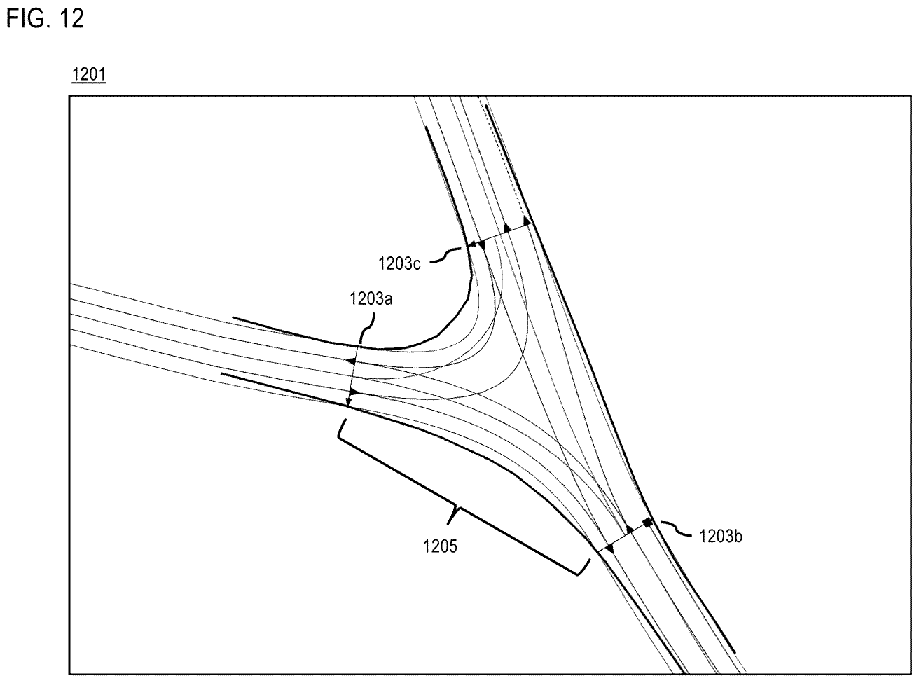

FIG. 12 is a diagram of an example of determining travels paths through a detected intersection, according to one example embodiment. In this example, the mapping platform 109 has processed a triangular mesh representation of a three-way intersection 1201 to determine the extents 1203a-1203c of the intersection 1201. The travel paths 1205 can then be calculated according to the various embodiments of the process described above. The determined travel paths can then be stored as an attribute of the intersection.

It is noted that the above examples of detecting and/or characterizing various attributes of the intersection using mesh triangulation is provided by way of illustration and not as limitations. It is contemplated that any attributes extractable from the triangular mesh are also applicable to the embodiments described herein.

In step 409, the output module 307 stores, using a processor, the detected road intersection and/or characteristics/attributes of the intersection as a data record of a geographic database 101 or equivalent database. In addition or alternatively, the output module 307 can provide the detected intersection and/or attributes as an output with or without storing the data records. For example, the stored data records and/or output can be provided to the services platform 117, services 119, content providers 121, vehicle 107, client terminal 111, application 113, and/or any other component of the system 100 to perform location based functions. One example of the location-based function is used for autonomous/semi-autonomous vehicle operation.

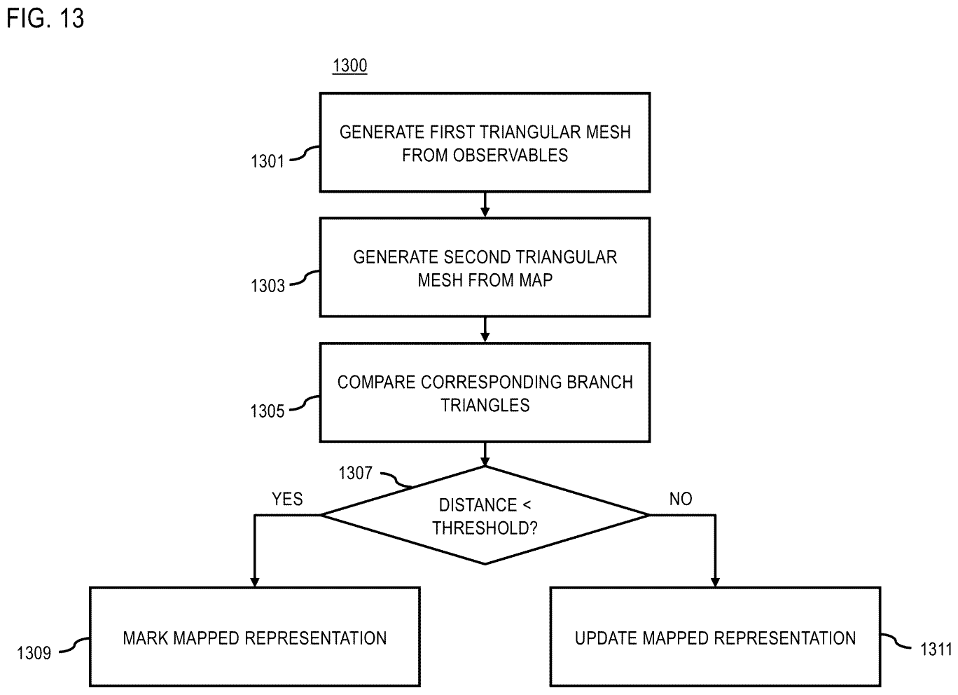

FIG. 13 is a flowchart of a process 1300 for comparing triangular mesh representations of an intersection, according to one example embodiment. In various embodiments, the mapping platform 109 and/or any of the modules 301-307 of the mapping platform 109 may perform one or more portions of the process 1300 and may be implemented in, for instance, a chip set including a processor and a memory as shown in FIG. 17 or in circuitry, hardware, firmware, software, or in any combination thereof. As such, the mapping platform 109 and/or the modules 301-307 can provide means for accomplishing various parts of the process 1300, as well as means for accomplishing embodiments of other processes described herein in conjunction with other components of the system 100. Although the process 1300 is illustrated and described as a sequence of steps, it is contemplated that various embodiments of the process 1300 may be performed in any order or combination and need not include all of the illustrated steps.

The process 1300 is discussed with respect to two types of representations of an intersection determined from two different sources: (1) sensor derived representation, and (2) map derived representation. However, it is contemplated that any two different representations regardless of the source (e.g., including different representations from the same source) can be used according to the various embodiments of the process 1300.

In step 1301, the triangulation module 303 generates a first triangular mesh (e.g., Delaunay mesh) based on a plurality of point observations of one or more boundaries of the road intersection according to the various embodiments of the mesh triangulation process described above. The plurality of point observations are determined from sensor derived data. For example, sensor derived data includes but are not limited to in vehicle sensors (e.g., cameras and LiDAR) as well as other remote sensing features (e.g., satellite imagery) that are used to detect the boundaries of an intersection of interest. As discussed above, the sensor data indicating road boundaries are referred to as observables. In one embodiment, the sensor derived data is taken as ground truth for purposes of performing the comparison in the process 1300.

In step 1303, the triangulation module 303 generates a second triangular mesh (e.g., Delaunay mesh) based on a mapped representation of the road intersection determined from a geographic database. In other words, another source of road data is routing data which is hand built using data gathered from sensors on vehicles passing near the intersections. From the routing data which includes lane counts and approximate intersection locations, road boundaries can also be created. As previously described, the map data for generating the second triangular mesh can be the digital map data of the geographic database. Generally, this map data can be standard definition map data that typically has an accuracy of 10 m. This map data can represent an intersection and road network using a node-link representation. The node link representation can be transformed into point representations (e.g., sampled at a designated interval such as 0.5 m) to create points that can be used as vertices of the mesh triangulation.

In step 1305, the detection module 305 selects at least one first branch triangle from the first triangular mesh (e.g., sensor derived triangular mesh generated in step 1301). According to the previously described embodiments for determining branch triangles, the vertices of the at least one first branch triangle reference three different road boundaries of the one or more road boundaries. The detection module 305 also selects at least one second branch triangle from the second triangular mesh (e.g., map derived triangular mesh generated in step 1303). The vertices of the at least one second branch triangle reference three different mapped road boundaries of the mapped representation. The detection module 305 can then perform a comparison of the at least one first branch triangle and the at least one second branch triangle.

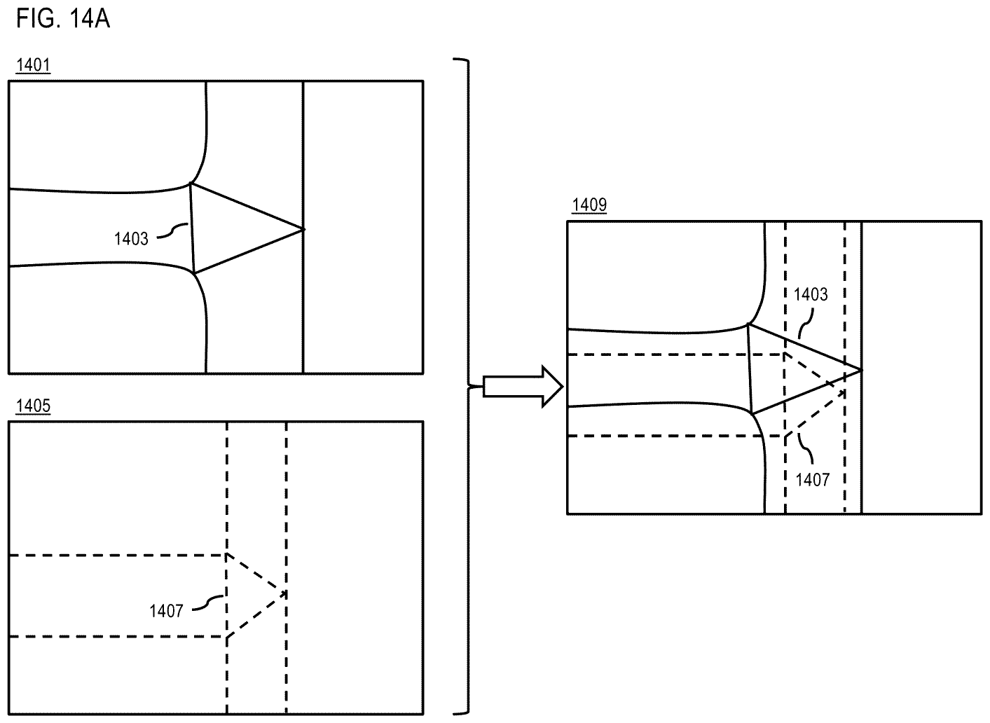

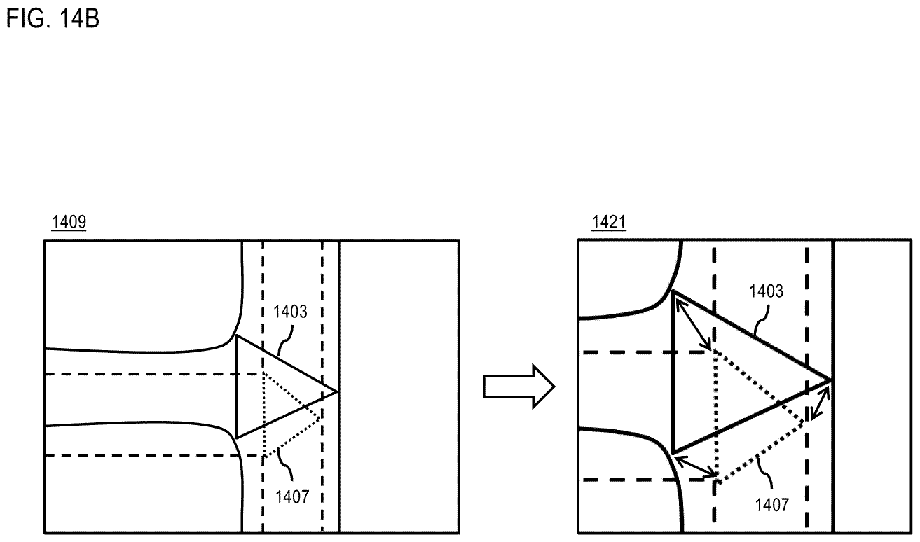

In one embodiment, the comparison can be performed by overlaying the selected branch triangles of the first triangular mesh and the second triangular mesh. FIGS. 14A and 14B are diagrams of an example of using measured distance to compare triangular mesh representations of an intersection, according to one embodiment. As shown in FIG. 14A, a first triangular mesh 1401 (e.g., generated from sensor derived data) of an intersection has been filtered to leave only the branch triangle 1403. A second triangular mesh 1405 (e.g., generated from map data of the geographic database 101) of the same intersection has been filtered to leave only the branch triangle 1407. The detection module 305 can overlay the first triangular mesh 1401 onto the second triangular mesh 1405 to generate the overlay 1409 showing the branch triangle 1403 superimposed on the branch triangle 1407.

Traditionally, it is difficult to compare the two intersections from different sources because they share nothing in common other than approximately being in the same location. However, using triangular meshes (e.g., Delaunay meshes) generated according to the various embodiments described herein enable the mapping platform 109 to do just that because of the special characteristics of the triangulation described above.

In step 1307, after generating the two filtered triangular meshes, the detection module 305 more specifically performs the comparison based on a measured distance between corresponding vertices of the one or more branch triangles and the one or more other branch triangles. As shown in FIG. 14B which continues the example of FIG. 14A, the overlay 1409 is used to measure the respective distances between the corresponding vertices of the branch triangle 1403 (of the sensor derived representation) and the branch triangle 1407 (of the mapped representation) as shown in cutout 1421 by the double arrows between the vertices. For example, the detection module 305 can compare the measured distance to a distance threshold. In one embodiment, the distance threshold is based on a maximum map error capable of supporting autonomous operation of a vehicle. In other embodiments, the distance threshold can be set to any value depending on a target map accuracy or any other specification requirements of a corresponding service or application.

Because there can be three measured distances corresponding to each of the three pairs of vertices between the compared branch triangles, it is contemplated that in one embodiment, the measured distance can be a maximum, an average, a minimum, weighted average, and/or the like of the measure distances between each vertex pair. Then this maximum, average, minimum, weighted average, etc. can be compared to the distance threshold.

In step 1309, if measured distance between the vertices is less than the distance threshold, the detection module 305 marks the mapped representation (e.g., corresponding to the second triangular mesh representation in the) as meeting an accuracy threshold based on a comparison of the at least one first branch triangle and the at least one second branch triangle. By way of example, the marking of the mapped representation comprises including a flag, field, or equivalent indicator in a data record of the mapped representation in the geographic database 101.

In step 1311, if the measured distance between the vertices is greater than the distance threshold, the detection module 305 can update the mapped representation in the geographic database based on a comparison of the at least one first branch triangle and the at least one second branch triangle. By way of example, the updating of the mapped representation comprises replacing the mapped representation with a representation of the road intersection generated from the plurality of point observations.

In one embodiment, the output (e.g., intersection data, intersection comparison data, etc.) of mapping platform can be used for automated map creation and/or update processes as described above. In other embodiments, the output can be transmitted over a communication network 115 to other components of the system 100 or other components with access to the system 100 such as but not limited to a services platform 117, services 119, content providers 121, and/or the like that can use the output of the system 100 to provide one or more functions, services, applications, etc.

Returning to FIG. 1, as shown and discussed above, the system 100 includes the mapping platform 109 for providing automated detection and/or characterization of road intersections. In one embodiment, the mapping platform 109 has connectivity or access to a one or more databases for storing the detected and/or characterized road intersections determined according to the various embodiments described herein, and as well as a geographic database 101 for retrieving mapping data and/or related attributes for automated detection and/or characterization of road intersections. In one embodiment, the geographic database 101 can include electronic or digital representations of mapped geographic features to facilitate detecting and/or characterizing road intersections. In one embodiment, the mapping platform 109 has connectivity over a communication network 115 to the services platform 117 that provides one or more services 119. By way of example, the services 119 may be third-party services that rely on location-based services created or developed intersection data generated according to the various embodiments described herein. By way of example, the services 119 include, but are not limited to, autonomous/semi-autonomous vehicle operation, mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services 119 uses the output of the mapping platform 109.

In one embodiment, the mapping platform 109 may be a platform with multiple interconnected components. The mapping platform 109 may include multiple servers, intelligent networking devices, computing devices, components, and corresponding software for automated detection and/or characterization of road intersections. In addition, it is noted that the mapping platform 109 may be separate entities of the system 100, a part of the one or more services 119, a part of the services platform 117, or included within the vehicles 107 and/or client terminals 111.

In one embodiment, content providers 121 may provide content or data (e.g., including geographic data, 3D models, parametric representations of mapped features, etc.) to the mapping platform 109, the services platform 117, the services 119, the client terminals 111, the vehicles 107, and/or an application 113 executing on the client terminal 111. The content provided may be any type of content, such as sensor data, map content, textual content, audio content, video content, image content, etc. used for detecting and/or characterizing road intersections. In one embodiment, the content providers 121 may also store content associated with the mapping platform 109, geographic database 101, services platform 117, services 119, client terminal 111, and/or vehicle 107. In another embodiment, the content providers 121 may manage access to a central repository of data, and offer a consistent, standard interface to data, such as a repository of the geographic database 101.

In one embodiment, the client terminal 111 and/or vehicle 107 may execute a software application 113 to capture sensor or other observation data (e.g., observables) for processing by mapping platform 109 according to the embodiments described herein. By way of example, the application 113 may also be any type of application that is executable on the client terminal 111 and/or vehicle 107, such as autonomous driving applications, mapping applications, location-based service applications, navigation applications, content provisioning services, camera/imaging application, media player applications, social networking applications, calendar applications, and the like. In one embodiment, the application 113 may act as a client for the mapping platform 109 and perform one or more functions associated with automated detection and/or characterization of road intersections alone or in combination with the mapping platform 109.

By way of example, the client terminal 111 is any type of computer system, embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the client terminal 111 can support any type of interface to the user (such as “wearable” circuitry, etc.). In one embodiment, the client terminal 111 may be associated with the vehicle 107 or be a component part of the vehicle 107.

In one optional embodiment, the client terminal 111 and/or vehicle 107 are configured with various sensors for generating or collecting sensor observations (e.g., for processing mapping platform 109), related geographic data, etc. In one embodiment, the sensed data represents sensor data associated with a geographic location or coordinates at which the sensor data was collected to detect road boundaries of an intersection. In this way, the sensor data can act as observation data that can be processed using mesh triangulation according to the various embodiments described herein. By way of example, the sensors may include a global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road boundaries, road sign information, images of road obstructions, etc. for analysis), LiDAR, radar, an audio recorder for gathering audio data, velocity sensors mounted on steering wheels of the vehicles, switch sensors for determining whether one or more vehicle switches are engaged, and the like.

Other examples of optional sensors of the client terminal 111 and/or vehicle 107 may include light sensors, orientation sensors augmented with height sensors and acceleration sensor (e.g., an accelerometer can measure acceleration and can be used to determine orientation of the vehicle), tilt sensors to detect the degree of incline or decline of the vehicle along a path of travel, moisture sensors, pressure sensors, etc. In a further example embodiment, sensors about the perimeter of the client terminal 111 and/or vehicle 107 may detect the relative distance of the vehicle to a road boundary, the presence of other vehicles, pedestrians, traffic lights, potholes and any other objects, or a combination thereof. In one scenario, the sensors may detect weather data, traffic information, or a combination thereof. In one embodiment, the client terminal 111 and/or vehicle 107 may include GPS or other satellite-based receivers to obtain geographic coordinates or signal for determine the coordinates from satellites. Further, the location can be determined by visual odometry, triangulation systems such as A-GPS, Cell of Origin, or other location extrapolation technologies. In yet another embodiment, the sensors can determine the status of various control elements of the car, such as activation of wipers, use of a brake pedal, use of an acceleration pedal, angle of the steering wheel, activation of hazard lights, activation of head lights, etc.

In another optional embodiment, the communication network 115 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), 5G New Radio Networks, Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 109, services platform 117, services 119, client terminal 111, vehicle 107, and/or content providers 121 optionally communicate with each other and other components of the system 100 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a datalink (layer 2) header, an internetwork (layer 3) header and a transport (layer 4) header, and various application (layer 5, layer 6 and layer 7) headers as defined by the OSI Reference Model.

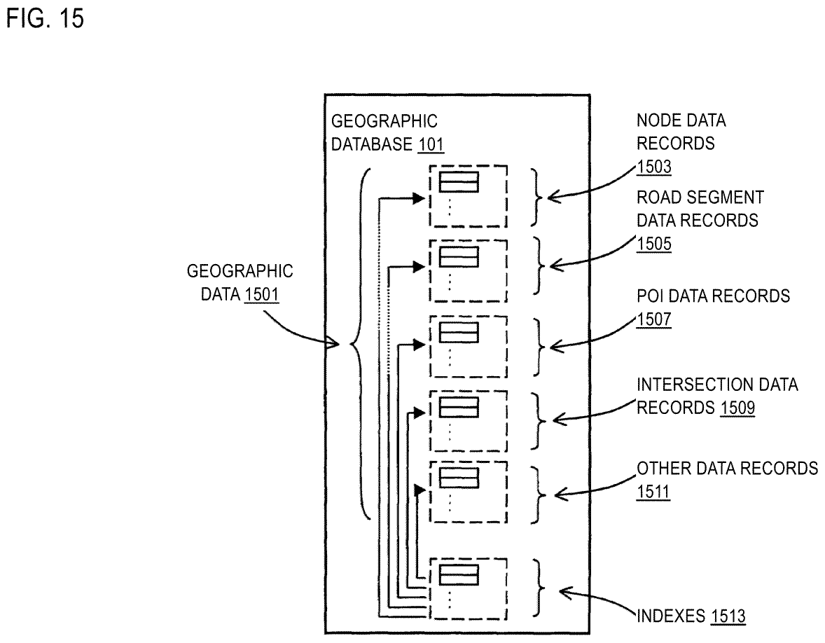

FIG. 15 is a diagram of the geographic database 101, according to one embodiment. In one embodiment, the geographic database 101 includes geographic data 1501 used for (or configured to be compiled to be used for) mapping and/or navigation-related services, such as for video odometry based on the parametric representation of signs include, e.g., encoding and/or decoding parametric representations into object models of signs. In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 101.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 101 follows certain conventions. For example, links do not cross themselves and do not cross each other except at a node. Also, there are no duplicated shape points, nodes, or links. Two links that connect each other have a common node. In the geographic database 101, overlapping geographic features are represented by overlapping polygons. When polygons overlap, the boundary of one polygon crosses the boundary of the other polygon. In the geographic database 101, the location at which the boundary of one polygon intersects the boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 101 includes node data records 1503, road segment or link data records 1505, POI data records 1507, intersection data records 1509, other records 1511, and indexes 1513, for example. More, fewer, or different data records can be provided. In one embodiment, additional data records (not shown) can include cartographic (“carto”) data records, routing data, and maneuver data. In one embodiment, the indexes 1513 may improve the speed of data retrieval operations in the geographic database 101. In one embodiment, the indexes 1513 may be used to quickly locate data without having to search every row in the geographic database 101 every time it is accessed. For example, in one embodiment, the indexes 1513 can be a spatial index of the polygon points associated with stored feature polygons.

In exemplary embodiments, the road segment data records 1505 are links or segments representing roads, streets, or paths, as can be used in the calculated route or recorded route information for determination of one or more personalized routes. The node data records 1503 are end points (such as intersections) corresponding to the respective links or segments of the road segment data records 1505. The road link data records 1505 and the node data records 1503 represent a road network, such as used by vehicles, cars, and/or other entities. Alternatively, the geographic database 101 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 101 can include data about the POIs and their respective locations in the POI data records 1507. The geographic database 101 can also include data about places, such as cities, towns, or other communities, and other geographic features, such as bodies of water, mountain ranges, etc. Such place or feature data can be part of the POI data records 1507 or can be associated with POIs or POI data records 1507 (such as a data point used for displaying or representing a position of a city).

In one embodiment, the geographic database 101 can also include intersection data records 1509 for storing generated triangular meshes, detected intersections, intersection attributes, intersection comparisons, and or any related data generated or used according to the various embodiments described herein. In one embodiment, the intersection records 1509 can be associated with one or more of the node records 1503, road segment records 1505, and/or POI data records 1507 to associate the detected and/or characterized intersections with specific geographic locations. In this way, the detected and/or characterized intersections can also be associated with the characteristics or metadata of the corresponding record 1503, 1505, and/or 1507.

In one embodiment, the geographic database 101 can be maintained by the content provider 121 in association with the services platform 117 (e.g., a map developer). The map developer can collect geographic data to generate and enhance the geographic database 101. There can be different ways used by the map developer to collect data. These ways can include obtaining data from other sources, such as municipalities or respective geographic authorities. In addition, the map developer can employ field personnel to travel by vehicle (e.g., vehicle 107 and/or client terminal 111) along roads throughout the geographic region to observe features and/or record information about them, for example. Also, remote sensing, such as aerial or satellite photography, can be used.

The geographic database 101 can be a master geographic database stored in a format that facilitates updating, maintenance, and development. For example, the master geographic database or data in the master geographic database can be in an Oracle spatial format or other spatial format, such as for development or production purposes. Map layers may be utilized. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 107 or client terminal 111, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing automated detection and/or characterization of road intersections may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular device, other network device, and/or other computing device.

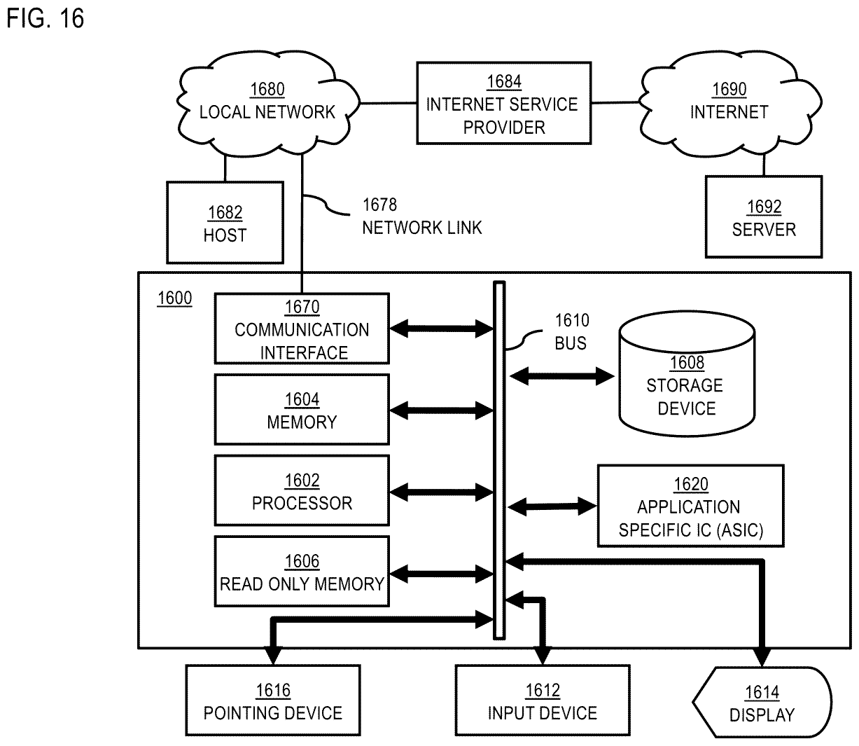

FIG. 16 illustrates a computer system 1600 upon which an embodiment of the invention may be implemented. Computer system 1600 is programmed (e.g., via computer program code or instructions) to provide automated detection and/or characterization of road intersections as described herein and includes a communication mechanism such as a bus 1610 for passing information between other internal and external components of the computer system 1600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1610 includes one or more parallel conductors of information so that information is transferred quickly among devices coupled to the bus 1610. One or more processors 1602 for processing information are coupled with the bus 1610.

A processor 1602 performs a set of operations on information as specified by computer program code related to providing automated detection and/or characterization of road intersections. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1610 and placing information on the bus 1610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1600 also includes a memory 1604 coupled to bus 1610. The memory 1604, such as a random access memory (RAM) or other dynamic storage device, stores information including processor instructions for providing automated detection and/or characterization of road intersections. Dynamic memory allows information stored therein to be changed by the computer system 1600. RAM allows a unit of information stored at a location called a memory address to be stored and retrieved independently of information at neighboring addresses. The memory 1604 is also used by the processor 1602 to store temporary values during execution of processor instructions. The computer system 1600 also includes a read only memory (ROM) 1606 or other static storage device coupled to the bus 1610 for storing static information, including instructions, that is not changed by the computer system 1600. Some memory is composed of volatile storage that loses the information stored thereon when power is lost. Also coupled to bus 1610 is a non-volatile (persistent) storage device 1608, such as a magnetic disk, optical disk, or flash card, for storing information, including instructions, that persists even when the computer system 1600 is turned off or otherwise loses power.

Information, including instructions for providing automated detection and/or characterization of road intersections, is provided to the bus 1610 for use by the processor from an external input device 1612, such as a keyboard containing alphanumeric keys operated by a human user, or a sensor. A sensor detects conditions in its vicinity and transforms those detections into physical expression compatible with the measurable phenomenon used to represent information in computer system 1600. Other external devices coupled to bus 1610, used primarily for interacting with humans, include a display device 1614, such as a cathode ray tube (CRT) or a liquid crystal display (LCD), or plasma screen or printer for presenting text or images, and a pointing device 1616, such as a mouse or a trackball or cursor direction keys, or motion sensor, for controlling a position of a small cursor image presented on the display 1614 and issuing commands associated with graphical elements presented on the display 1614. In some embodiments, for example, in embodiments in which the computer system 1600 performs all functions automatically without human input, one or more of external input device 1612, display device 1614 and pointing device 1616 is omitted.

In the illustrated embodiment, special purpose hardware, such as an application specific integrated circuit (ASIC) 1620, is coupled to bus 1610. The special purpose hardware is configured to perform operations not performed by processor 1602 quickly enough for special purposes. Examples of application specific ICs include graphics accelerator cards for generating images for display 1614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1600 also includes one or more instances of a communications interface 1670 coupled to bus 1610. Communication interface 1670 provides a one-way or two-way communication coupling to a variety of external devices that operate with their own processors, such as printers, scanners, and external disks. In general the coupling is with a network link 1678 that is connected to a local network 1680 to which a variety of external devices with their own processors are connected. For example, communication interface 1670 may be a parallel port or a serial port or a universal serial bus (USB) port on a personal computer. In some embodiments, communications interface 1670 is an integrated services digital network (ISDN) card or a digital subscriber line (DSL) card or a telephone modem that provides an information communication connection to a corresponding type of telephone line. In some embodiments, a communication interface 1670 is a cable modem that converts signals on bus 1610 into signals for a communication connection over a coaxial cable or into optical signals for a communication connection over a fiber optic cable. As another example, communications interface 1670 may be a local area network (LAN) card to provide a data communication connection to a compatible LAN, such as Ethernet. Wireless links may also be implemented. For wireless links, the communications interface 1670 sends or receives or both sends and receives electrical, acoustic, or electromagnetic signals, including infrared and optical signals, that carry information streams, such as digital data. For example, in wireless handheld devices, such as mobile telephones like cell phones, the communications interface 1670 includes a radio band electromagnetic transmitter and receiver called a radio transceiver. In certain embodiments, the communications interface 1670 enables connection to the communication network 115 for providing automated detection and/or characterization of road intersections.

The term computer-readable medium is used herein to refer to any medium that participates in providing information to processor 1602, including instructions for execution. Such a medium may take many forms, including, but not limited to, non-volatile media, volatile media, and transmission media. Non-volatile media include, for example, optical or magnetic disks, such as storage device 1608. Volatile media include, for example, dynamic memory 1604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1678 typically provides information communication using transmission media through one or more networks to other devices that use or process the information. For example, network link 1678 may provide a connection through local network 1680 to a host computer 1682 or to equipment 1684 operated by an Internet Service Provider (ISP). ISP equipment 1684 in turn provides data communication services through the public, world-wide packet-switching communication network of networks now commonly referred to as the Internet 1690.

A computer called a server host 1692 connected to the Internet hosts a process that provides a service in response to information received over the Internet. For example, server host 1692 hosts a process that provides information representing video data for presentation at display 1614. It is contemplated that the components of system can be deployed in various configurations within other computer systems, e.g., host 1682 and server 1692.

FIG. 17 illustrates a chip set 1700 upon which an embodiment of the invention may be implemented. Chip set 1700 is programmed to provide automated detection and/or characterization of road intersections as described herein and includes, for instance, the processor and memory components described with respect to FIG. 16 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1700 includes a communication mechanism such as a bus 1701 for passing information among the components of the chip set 1700. A processor 1703 has connectivity to the bus 1701 to execute instructions and process information stored in, for example, a memory 1705. The processor 1703 may include one or more processing cores with each core configured to perform independently. A multi-core processor enables multiprocessing within a single physical package. Examples of a multi-core processor include two, four, eight, or greater numbers of processing cores. Alternatively or in addition, the processor 1703 may include one or more microprocessors configured in tandem via the bus 1701 to enable independent execution of instructions, pipelining, and multithreading. The processor 1703 may also be accompanied with one or more specialized components to perform certain processing functions and tasks such as one or more digital signal processors (DSP) 1707, or one or more application-specific integrated circuits (ASIC) 1709. A DSP 1707 typically is configured to process real-world signals (e.g., sound) in real time independently of the processor 1703. Similarly, an ASIC 1709 can be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1703 and accompanying components have connectivity to the memory 1705 via the bus 1701. The memory 1705 includes both dynamic memory (e.g., RAM, magnetic disk, writable optical disk, etc.) and static memory (e.g., ROM, CD-ROM, etc.) for storing executable instructions that when executed perform the inventive steps described herein to provide automated detection and/or characterization of road intersections. The memory 1705 also stores the data associated with or generated by the execution of the inventive steps.

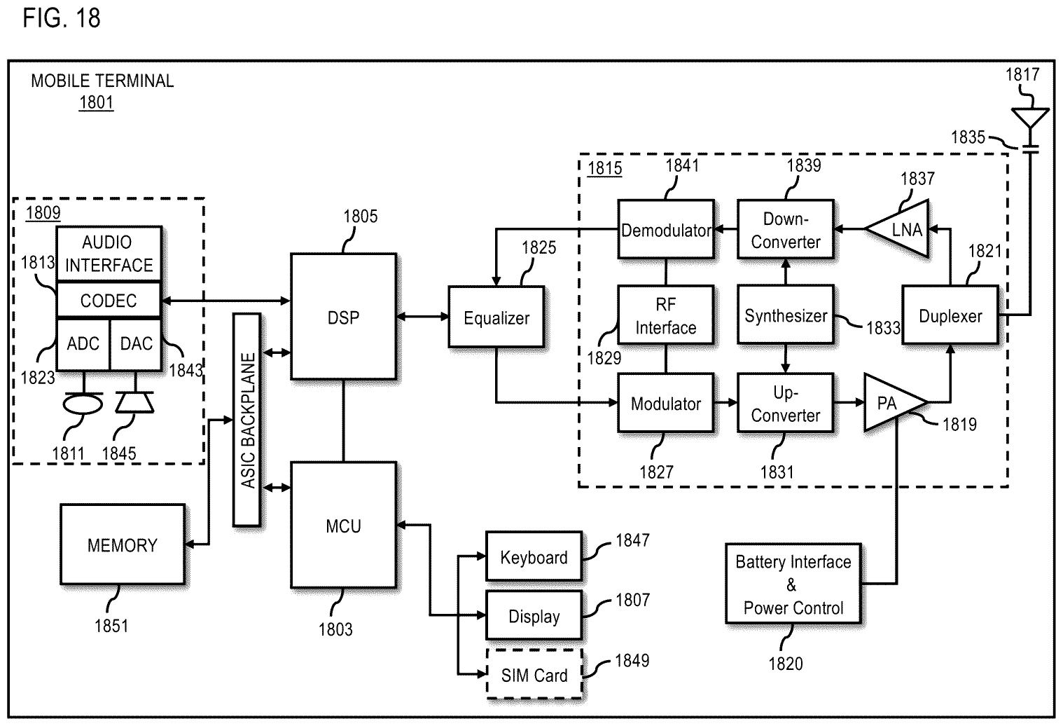

FIG. 18 is a diagram of exemplary components of a mobile terminal 1801 (e.g., client terminal 111, vehicle 107, or component thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1803, a Digital Signal Processor (DSP) 1805, and a receiver/transmitter unit including a microphone gain control unit and a speaker gain control unit. A main display unit 1807 provides a display to the user in support of various applications and mobile station functions that offer automatic contact matching. An audio function circuitry 1809 includes a microphone 1811 and microphone amplifier that amplifies the speech signal output from the microphone 1811. The amplified speech signal output from the microphone 1811 is fed to a coder/decoder (CODEC) 1813.

A radio section 1815 amplifies power and converts frequency in order to communicate with a base station, which is included in a mobile communication system, via antenna 1817. The power amplifier (PA) 1819 and the transmitter/modulation circuitry are operationally responsive to the MCU 1803, with an output from the PA 1819 coupled to the duplexer 1821 or circulator or antenna switch, as known in the art. The PA 1819 also couples to a battery interface and power control unit 1820.

In use, a user of mobile station 1801 speaks into the microphone 1811 and his or her voice along with any detected background noise is converted into an analog voltage. The analog voltage is then converted into a digital signal through the Analog to Digital Converter (ADC) 1823. The control unit 1803 routes the digital signal into the DSP 1805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1825 for compensation of any frequency-dependent impairments that occur during transmission through the air such as phase and amplitude distortion. After equalizing the bit stream, the modulator 1827 combines the signal with a RF signal generated in the RF interface 1829. The modulator 1827 generates a sine wave by way of frequency or phase modulation. In order to prepare the signal for transmission, an up-converter 1831 combines the sine wave output from the modulator 1827 with another sine wave generated by a synthesizer 1833 to achieve the desired frequency of transmission. The signal is then sent through a PA 1819 to increase the signal to an appropriate power level. In practical systems, the PA 1819 acts as a variable gain amplifier whose gain is controlled by the DSP 1805 from information received from a network base station. The signal is then filtered within the duplexer 1821 and optionally sent to an antenna coupler 1835 to match impedances to provide maximum power transfer. Finally, the signal is transmitted via antenna 1817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1801 are received via antenna 1817 and immediately amplified by a low noise amplifier (LNA) 1837. A down-converter 1839 lowers the carrier frequency while the demodulator 1841 strips away the RF leaving only a digital bit stream. The signal then goes through the equalizer 1825 and is processed by the DSP 1805. A Digital to Analog Converter (DAC) 1843 converts the signal and the resulting output is transmitted to the user through the speaker 1845, all under control of a Main Control Unit (MCU) 1803—which can be implemented as a Central Processing Unit (CPU) (not shown).

The MCU 1803 receives various signals including input signals from the keyboard 1847. The keyboard 1847 and/or the MCU 1803 in combination with other user input components (e.g., the microphone 1811) comprise a user interface circuitry for managing user input. The MCU 1803 runs a user interface software to facilitate user control of at least some functions of the mobile station 1801 to provide automated detection and/or characterization of road intersections. The MCU 1803 also delivers a display command and a switch command to the display 1807 and to the speech output switching controller, respectively. Further, the MCU 1803 exchanges information with the DSP 1805 and can access an optionally incorporated SIM card 1849 and a memory 1851. In addition, the MCU 1803 executes various control functions required of the station. The DSP 1805 may, depending upon the implementation, perform any of a variety of conventional digital processing functions on the voice signals. Additionally, DSP 1805 determines the background noise level of the local environment from the signals detected by microphone 1811 and sets the gain of microphone 1811 to a level selected to compensate for the natural tendency of the user of the mobile station 1801.

The CODEC 1813 includes the ADC 1823 and DAC 1843. The memory 1851 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1851 may be, but not limited to, a single memory, CD, DVD, ROM, RAM, EEPROM, optical storage, or any other non-volatile or non-transitory storage medium capable of storing digital data.

An optionally incorporated SIM card 1849 carries, for instance, important information, such as the cellular phone number, the carrier supplying service, subscription details, and security information. The SIM card 1849 serves primarily to identify the mobile station 1801 on a radio network. The card 1849 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method of an automated detection of a road intersection comprising:
determining, using a processor, a set of observables associated with the road intersection, wherein the set of observables comprises a plurality of point observations of one or more road boundaries of the road intersection, and wherein the plurality of point observations are collected using one or more sensors of at least one vehicle traveling in the road intersection;
processing, using the processor, the plurality of point observations to generate a triangular mesh to represent a surface of the road intersection, wherein the triangular mesh comprises a plurality of triangles connecting the plurality of point observations as respective vertices of the plurality of triangles;
selecting, using the processor, one or more branch triangles of the plurality of triangles, wherein the vertices of the one or more branch triangles reference three different road boundaries of the road intersection;
automatically detecting, using the processor, the road intersection based on the one or more branch triangles; and
storing, using the processor, the detected road intersection as a data record of a geographic database.

2. The method of claim 1, wherein the triangular mesh is generated so that no vertex of the plurality of triangles falls in the interior of a circumcircle of any triangle of the plurality of triangles.

3. The method of claim 2, wherein the triangular mesh is generated using Delaunay triangulation.

4. The method of claim 1, further comprising:
determining a mapped representation of the road intersection from the geographic database, wherein the mapped representation comprises one or more mapped road boundaries of the road intersection;
processing the one or more mapped road boundaries to generate a mapped triangular mesh to represent the mapped representation based on the one or more mapped road boundaries;
selecting one or more other branch triangles of the mapped triangular mesh, wherein vertices of the one or more other branch triangles reference three different mapped road boundaries of the mapped representation;
performing a comparison of the one or more branch triangles selected from the triangular mesh and the one or more other branch triangles of the mapped triangular mesh; and
determining to update the mapped representation in the geographic database based on the comparison.

5. The method of claim 4, wherein the comparison is based on a measured distance between corresponding vertices of the one or more branch triangles and the one or more other branch triangles.

6. The method of claim 1, further comprising:
determining a number of entry or exit roads of the road intersection based on a number of the one or more branch triangles selected from the triangular mesh.

7. The method of claim 1, wherein the entry or exit roads are detected based on one or more free edges of the one or more branch triangles.

8. The method of claim 1, further comprising:
determining an extent of the road intersection based on a position where an entry or exit road of the road intersection starts to widen by starting at a free edge of the one or more branch triangles, and following one or more bridge triangles of the triangular mesh along the entry or exit road until a width of the entry or exit road remains constant within a threshold value,
wherein vertices of the one or more bridge triangles reference exactly two different road boundaries of the road intersection.

9. The method of claim 8, wherein an accessor to the road intersection is determined based on the extent of the road intersection.

10. The method of claim 1, wherein the plurality of point observations is sampled at a designated distance interval.

11. An apparatus for automated detection of a road intersection comprising:
at least one processor; and
at least one memory including computer program code for one or more programs,
the at least one memory and the computer program code configured to, with the at least one processor, cause the apparatus to perform at least the following,
generate a first triangular mesh based on a plurality of point observations of one or more boundaries of the road intersection, and a second triangular mesh based on a mapped representation of the road intersection determined from a geographic database;
select at least one first branch triangle from the first triangular mesh, wherein vertices of the at least one first branch triangle reference three different road boundaries of the one or more road boundaries;
select at least one second branch triangle from the second triangular mesh, wherein vertices of the at least one second branch triangle reference three different mapped road boundaries of the mapped representation; and
mark the mapped representation as meeting an accuracy threshold, update the mapped representation in the geographic database, or a combination thereof based on a comparison of the at least one first branch triangle and the at least one second branch triangle.

12. The apparatus of claim 11, wherein the comparison is based on a measured distance between corresponding vertices of the one or more branch triangles and the one or more other branch triangles.

13. The apparatus of claim 12, wherein the mapped representation is updated based on determining that the measured distance is greater than a distance threshold.

14. The apparatus of claim 13, wherein the distance threshold is based on a maximum map error capable of supporting autonomous operation of a vehicle.

15. The apparatus of claim 11, wherein the updating of the mapped representation comprises replacing the mapped representation with a representation of the road intersection generated from the plurality of point observations.

16. A non-transitory computer-readable storage medium for an automated detection of an intersection, carrying one or more sequences of one or more instructions which, when executed by one or more processors, cause an apparatus to perform:
determining a set of observables associated with the intersection, wherein the set of observables comprises a plurality of point observations of one or more boundaries of the intersection, and wherein the plurality of point observations are collected using one or more sensors of at least one device traveling in the intersection;
processing the plurality of point observations to generate a triangular mesh to represent a surface of the intersection, wherein the triangular mesh comprises a plurality of triangles connecting the plurality of point observations as respective vertices of the plurality of triangles;
selecting one or more branch triangles of the plurality of triangles, wherein the vertices of the one or more branch triangles reference three different boundaries of the road intersection;
automatically detecting the intersection based on the one or more branch triangles; and
providing the detected intersection as an output.

17. The non-transitory computer-readable storage of claim 16, wherein the triangular mesh is generated so that no vertex of the plurality of triangles falls in the interior of a circumcircle of any triangle of the plurality of triangles.

18. The non-transitory computer-readable storage of claim 17, wherein the triangular mesh is generated using Delaunay triangulation.

19. The non-transitory computer-readable storage of claim 16, wherein the apparatus is caused to further perform:
determining a mapped representation of the intersection, wherein the mapped representation comprises one or more mapped boundaries of the intersection;
processing the one or more mapped boundaries to generate a mapped triangular mesh to represent the mapped representation based on the one or more mapped road boundaries;
selecting one or more other branch triangles of the mapped triangular mesh, wherein vertices of the one or more other triangles reference three different mapped boundaries of the one or more mapped boundaries of the mapped representation;
performing a comparison of the one or more branch triangles selected from the triangular mesh and the one or more other branch triangles of the mapped triangular mesh; and
determining to update the mapped representation in a geographic database based on the comparison.

20. The non-transitory computer-readable storage of claim 19, wherein the comparison is based on a measured distance between corresponding vertices of the one or more branch triangles and the one or more other branch triangles.
